(19) United States
(12) Patent Application Publication
(10) Pub. No.: US 2022/0138636 A1
(43) Pub. Date: May 5, 2022

(54) TRAVEL PLANNING SYSTEMS AND METHODS FOR PROVIDING TRAVEL ITINERARIES AND THEIR CARBON FOOTPRINT

(71) Applicant: Wayaj, Inc., Jericho, NY (US)

(72) Inventors: Nelly O. Gedeon, Jericho, NY (US); Logan Aaron Cohen, Commack, NY (US)

(21) Appl. No.: 17/509,714

(22) Filed: Oct. 25, 2021

Related U.S. Application Data
(60) Provisional application No. 63/156,589, filed on Mar. 4, 2021.
(60) Provisional application No. 63/107,908, filed on Oct. 30, 2020.

(51) Int. Cl. G06Q 10/02; G06Q 30/00; G06Q 50/14

(52) U.S. Cl. CPC G06Q 10/02; G06Q 50/14; G06Q 30/018

(57) ABSTRACT

A system for determining a carbon footprint includes a graphical user interface (GUI), including a display, a processor, and a memory. The memory includes instructions stored thereon, which, when executed by the processor, cause the system to receive input from the GUI, the input including a travel itinerary inquiry, determine a provider listing based on the received travel itinerary inquiry, display the determined provider listing on the GUI, receive a second input from the GUI, the second input including a listing selection, determine a carbon footprint value based on the listing selection, and display the carbon footprint value and the listing selection on the GUI. The travel itinerary inquiry is at least one of an accommodations inquiry, transportation inquiry, or experiences inquiry.

### CROSS REFERENCE TO RELATED APPLICATIONS

This application claims the benefit of, and priority to, U.S. Provisional Patent Application No. 63/107,908, filed on Oct. 30, 2020 and claims the benefit of, and priority to, U.S. Provisional Patent Application No. 63/156,589, filed on Mar. 4, 2021.

### TECHNICAL FIELD

The present disclosure relates to systems and methods for travel booking and reservation systems, more particularly, to systems and methods for providing environmentally friendly travel options, calculating the carbon footprint of a trip, and managing and providing travel options based on a carbon footprint.

### BACKGROUND

There is a desire among people to reduce their carbon footprints in their efforts to be environmentally friendly. Most individuals' efforts to be more environmentally friendly occur in their daily lives, and there are myriads of methods, organizations, companies, and tools people can use to reduce their carbon footprint. Travel, including transportation and accommodation related to travel, tends to have a large carbon footprint. In efforts to keep their carbon footprint low, travelers have increasingly looked for ways to reduce their carbon footprint. However, finding environmentally-friendly accommodations and modes of transportation is difficult and often cumbersome for an individual. Further, it is often difficult to avoid using resources with a large carbon footprint, and some travelers want options to offset their carbon footprint due to their travel plans. Often, information provided to consumers regarding accommodations or transportation modes is generalized and broad and is not tailored to the individual's itineraries making it difficult to assess their carbon footprint. Accordingly, there is a desire for a centralized system and method for determining the carbon footprint of future, present, or past travel that displays an individual's carbon footprint due to their travel plan.

### SUMMARY

The present disclosure relates to a system for determining a carbon footprint. The system includes a graphical user interface (GUI) including a display, a processor, and a memory. The memory includes instructions stored thereon, which, when executed by the processor, cause the system to receive input from the GUI, the input including a travel itinerary inquiry. The system determines at least one provider listing to be displayed based on the received travel itinerary inquiry. The system displays the determined provider listing on the GUI. The system receives a second input from the GUI. The second input includes a listing selection from the at least one provider listing displayed. The system determines a carbon footprint value based on the listing selection and displays the carbon footprint value and the listing selection on the GUI. The travel itinerary inquiry is at least one of an accommodations inquiry, transportation inquiry, or experiences inquiry.

In aspects, the carbon footprint value may further be based on at least one of: the travel itinerary inquiry, carbon emissions data, or listings data.

In other aspects, the carbon footprint value may include determining at least one of a stationary emissions total, mobile fuel emissions total, a fugitive emissions fuel total, electricity emissions total, district heating emissions total, district cooling emissions total, or emissions due to laundry total.

In further aspects, the carbon footprint value may be determined by determining the carbon emissions value of the in-room products, fuels, water, cleaning services, food, waste, furniture, and objects consumed or used by the provider's service or facility.

In alternative aspects, the carbon footprint value may be further determined based on travel dates of the travel itinerary inquiry and an amount of travelers of the travel itinerary inquiry.

In further aspects, the instructions, when executed by the processor, may further cause the system to: determine the carbon footprint value of each traveler of the amount of travelers and display the carbon footprint value of each traveler based on the listing selection on the GUI.

In aspects, the instructions, when executed by the processor, may further cause the system to determine at least one carbon offset project to be displayed based on the travel inquiry and display the carbon offset project on the display.

In aspects, the instructions, when executed by the processor, may further cause the system to: receive a third input from the GUI including a selection of the at least one carbon offset project.

In additional aspects, the instructions, when executed by the processor, may further cause the system to: receive a third input from the GUI indicating a consumer carbon offset project selection.

In yet additional aspects, the instructions, when executed by the processor, may further cause the system to: process a carbon offset project payment based on the consumer carbon offset project selection; and book a reservation based on the listing selection with a provider.

This disclosure also presents a method for determining a carbon footprint. The method includes: receiving input from a graphical user interface (GUI) of a display, the input including a travel itinerary inquiry; determining a provider listing based on the received travel itinerary inquiry; displaying the determined provider listing on the GUI; receiving a second input from the GUI, the second input including a selection of the provider listing; determining a carbon footprint value based on the selection of the provider listing; and displaying the carbon footprint value and the provider listing selection on the GUI.

In aspects, the method may include determining the carbon footprint value based on at least one of: the travel itinerary inquiry, carbon emissions data, or listings data.

In other aspects, determining the carbon footprint value may include determining at least one of a stationary emissions total, mobile fuel emissions total, a fugitive emissions fuel total, electricity emissions total, district heating emissions total, district cooling emissions total, or emissions due to laundry total.

In yet other aspects, determining the carbon footprint value may include determining the carbon emissions value of the in-room products, fuels, water, cleaning services, food, waste, furniture, and objects consumed or used by the provider's service or facility.

In aspects, the carbon footprint value may be further determined based on travel dates of the travel itinerary inquiry and an amount of travelers of the travel itinerary inquiry.

In some aspects, the method may include determining the carbon footprint value of each traveler of the amount of travelers and displaying the carbon footprint value of each traveler based on the listing selection on the GUI.

In further aspects, the method may include: determining a consumer carbon offset project to be displayed; and displaying, on a display, the accessed consumer carbon offset project.

In an aspect, the method may include receiving a third input from the GUI indicating a consumer carbon offset project selection, processing a carbon offset project payment based on the consumer carbon offset project selection, and booking the provider listing selection.

This disclosure also presents another method for reserving a travel itinerary including receiving, via a graphical user interface (GUI) of a display, a listings selection from a list of provider listings displayed on the display; determining a carbon footprint associated with the listings selection; displaying the determined carbon footprint; determining at least one consumer carbon offset project to be displayed; and receiving, via the GUI, at least one selection from the carbon offset projects displayed on the display; receiving a payment based on the at least one selection from the carbon offset projects displayed on the display.

In aspects, the method may further include reserving the listings selection from the list of provider listings with a provider.

In aspects, the list of provider listings includes at least one of an accommodation listings, a transportation listing, or an experience listing.

### BRIEF DESCRIPTION OF THE DRAWINGS

Various aspects and features of the disclosure are described herein with reference to the drawings wherein:

FIG. 1 is a diagram of an exemplary computing device;

FIG. 2 is a block diagram of an exemplary system for providing environmentally friendly travel listings and carbon footprints of the travel listings;

FIG. 3 is a block diagram of another exemplary system for providing travel listings and carbon footprints of the travel listings, in accordance with another aspect of the disclosure;

FIG. 4 is a block diagram of a provider dashboard of the system of FIG. 2 of this disclosure;

FIG. 5 is a block diagram of a traveler dashboard of the system of FIG. 2 of this disclosure;

FIG. 6 is a block diagram of an administrator dashboard for managing providers of the system of FIG. 2 of this disclosure;

FIGS. 7A-B is a block diagram of an administrator dashboard of the system of FIG. 2;

FIG. 8 is a diagram of a method for providing travel plans, associated carbon footprints of the travel plans, and carbon offset projects to a traveler;

FIG. 9 is a diagram of a method for determining carbon footprints of a travel provider's services;

FIG. 10 is a diagram of a method for receiving provider listings and determining carbon footprints of the provider listings;

FIGS. 11A-D are illustrations of exemplary user interfaces of the system of FIG. 2 for collecting carbon emissions data;

FIG. 12 is an illustration of an exemplary user interface of the system of FIG. 2 for collecting provider listings data;

FIG. 13 is an illustration of an administrator interface of the system of FIG. 2 for configuring a carbon footprint calculator for a provider listing;

FIG. 14 is an illustration of an administrator interface of the system of FIG. 2 for managing provider listings;

FIG. 15 are illustrations of an administrator interface of the system of FIG. 2 for managing carbon emission factors and related data for a stored provider listing;

FIG. 16 is an illustration of an administrator interface of the system of FIG. 2 for creating carbon emission factors and related data for a new provider listing;

FIG. 17 is an illustration of the administrator interface of the system of FIG. 2 for managing provider listings of FIG. 14 with the new provider listing from FIG. 16 shown;

FIG. 18 are an illustration of an administrator interface of the system of FIG. 2 for a carbon footprint calculator;

FIG. 19 is an illustration of a provider interface for managing carbon emission factors and related data, of the provider's listing;

FIGS. 20A-C are illustrations of a provider interface for a carbon footprint calculator;

FIG. 21 is an illustration of a traveler interface for a travel itinerary carbon footprint calculator; and

FIG. 22 is an illustration of a traveler interface for displaying carbon offset projects to reduce or negate a carbon footprint due to travel.

### DETAILED DESCRIPTION

The terms “computer,” “computing device,” “mobile device,” and “server” may refer to a computer including a processor and a memory, which include processor-executable instructions. When the processor executes the processor-executable instructions, the computer performs any features or functions to provide functionalities of this disclosure.

The terms “application,” “module,” “unit,” and “software” may include a computer program designed to perform particular functions, tasks, or activities for the benefit of a user. “Application” may refer to, for example, software running locally or remotely, as a standalone program or in a web browser, or other software that would be understood by one skilled in the art to be an application. An application may run on a user device, including, for example, on a portable computing device, computer device, an internet-of-thing (IoT) device, or a server system.

The term “providers” includes hotels, hostels, motels, vacation home rentals, and other accommodation entities, and may also refer to transportation rental agencies, bus services, train operators, airlines, and the like that provide transportation-related services to travelers. Providers may also refer to businesses and entities offering activities (e.g., golfing, kayaking, etc.) or experiences (e.g., museums, tours, concerts, etc.)

The terms “consumers” and “travelers” are used interchangeably herein to include people who are traveling, planning to travel, or have already traveled. Consumers and travelers use the services offered by the providers during their travels.

The terms “travel plans,” “plans,” “booked listings,” and “itineraries” are used interchangeably herein to refer to past, present, or future travel plans of a consumer or traveler.

This disclosure provides travel planning systems, carbon footprint calculators, and methods thereof for providing travel listings, calculating travel-related carbon footprints, and reducing a traveler's net carbon footprint. Travelers are increasingly considering their environmental impact associated with their travel plans, whether traveling for business, leisure, personal reasons, etc. However, current travel planning systems do not allow travelers (or providers) to see and understand the impact of their travels or particular itinerary, and at best provide generalized carbon footprints of a theoretical itinerary. The travel planning systems and carbon footprint calculators of this disclosure solve this issue by providing travelers and providers the ability to see the carbon footprint of a specific travel itinerary and be able to offset or reduce their carbon footprint, (e.g., offset their carbon footprint to be net zero or less).

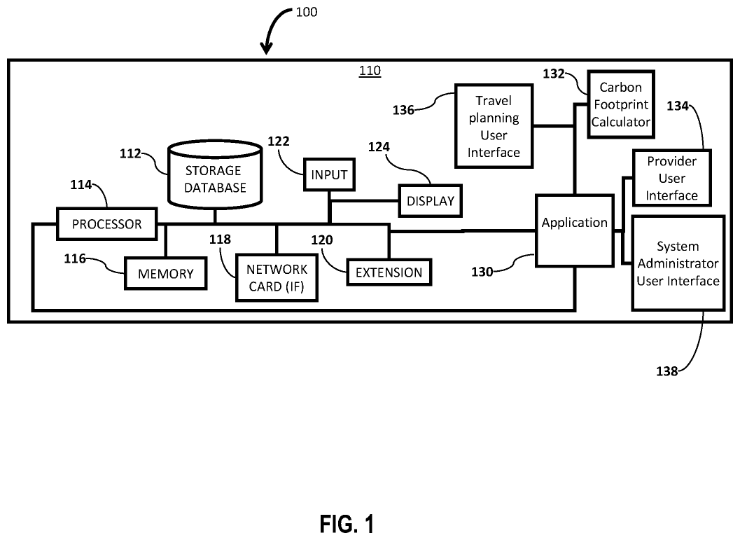

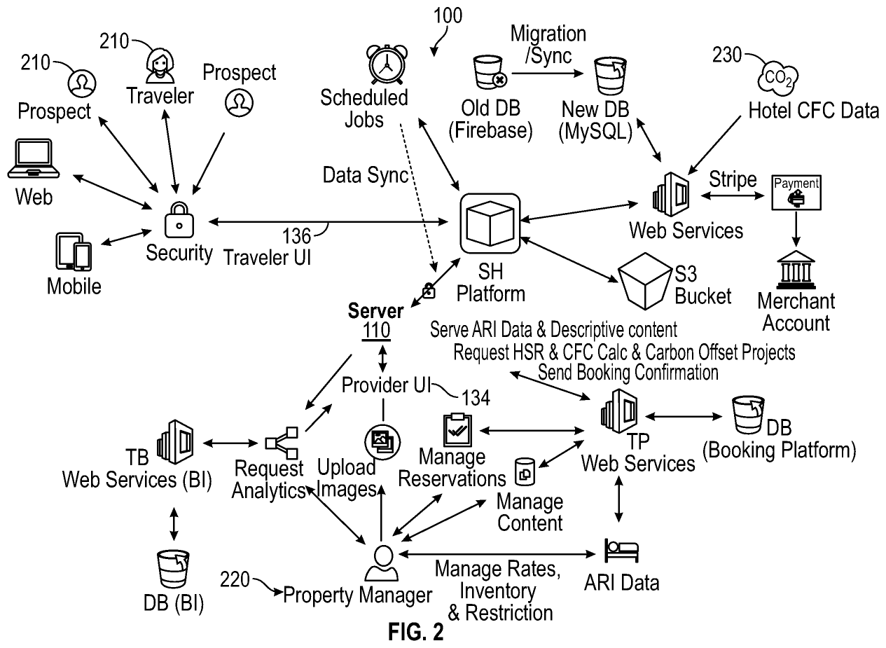

With reference to FIG. 1, a travel planning system 100 generally includes a server 110, a database 112, a processor 114, memory 116, an input device 122, a display 124, and a travel planning application 130 including a carbon footprint engine 132, a provider listing user interface (UI) 134, a travel planning UI 136, and a system administrator UI 138. The travel planning system 100 may further include a network interface 118 or an extension 120.

The server 110 may be connected to one or more external devices and control the external devices. The server 112 may include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and/or embedded computers. Those of skill in the art will recognize that many smartphones are suitable for use in the system described herein. Suitable tablet computers include those with booklet, slate, and/or convertible configurations, known to those of skill in the art.

In aspects, the server 110 includes an operating system configured to perform executable instructions. The operating system is, for example, software, including programs and/or data, which manages the device's hardware and provides services for the execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In aspects, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In aspects, the server 110 includes memory 116 or database 112. The database 112 and memory 116 are each one or more physical apparatus used to store data or programs on a temporary or permanent basis. In aspects, the database 112 or memory 116 may be volatile memory and requires power to maintain stored information. In aspects, database 112 or memory 116 may be non-volatile memory and retains stored information when the server 110 is not powered. In aspects, the non-volatile memory includes flash memory. In aspects, the non-volatile memory includes dynamic random-access memory (DRAM). In aspects, the non-volatile memory includes ferroelectric random-access memory (FRAM). In aspects, the non-volatile memory includes phase-change random access memory (PRAM). In aspects, the database 112 or memory 116 include, by way of non-limiting examples, CD-ROMs, DVDs, flash memory devices, magnetic disk drives, magnetic tapes drives, optical disk drives, and cloud computing-based storage. In aspects, database 112 or memory 116 may each be a combination of devices such as those disclosed herein. The memory 116 may be configured to store an application having instructions. The database 112 may be configured to store listings data, carbon emissions data, and COPs data.

The processor 114 executes instructions that implement tasks or functions of programs. When a user executes a program, the processor 114 reads the instructions (e.g., a program) stored in the database 112 or memory 116, loads the program on the RAM, and executes instructions prescribed by the program.

The processor 114 may be a microprocessor, central processing unit (CPU), application-specific integrated circuit (ASIC), arithmetic coprocessor, graphic processor, or image processor, each of which is electronic circuitry within a computer that carries out instructions of a computer program by performing the basic arithmetic, logical, control and input/output (I/O) operations specified by the instructions.

In aspects, the extension 120 may include several ports, such as one or more universal serial buses (USBs), IEEE 1394 ports, parallel ports, and/or expansion slots such as peripheral component interconnect (PCI) and PCI express (PCIe). The extension 120 is not limited to the list but may include other slots or ports that can be used for appropriate purposes. Extension 120 may be used to install hardware or add additional functionalities to a computer that may facilitate the purposes of the computer. For example, a USB port can be used for adding additional storage to the computer, and/or an IEEE 1394 may be used for receiving moving/still image data.

In aspects, the display 124 may be a cathode ray tube (CRT), a liquid crystal display (LCD), or light-emitting diode (LED). In aspects, the display 124 may be a thin film transistor liquid crystal display (TFT-LCD). In aspects, the display 124 may be an organic light-emitting diode (OLED) display. In various aspects, the OLED display is a passive-matrix OLED (PMOLED) or active-matrix OLED (AMOLED) display. In aspects, the display 124 may be a plasma display. In aspects, the display 124 may be a video projector. In aspects, the display may be interactive (e.g., having a touch screen or a sensor such as a camera, a 3D sensor, LiDAR, a radar, etc.) that can detect user interactions/gestures/responses and the like. In still other aspects, display 124 is a combination of devices such as those disclosed herein.

A user may input and/or modify data via the input device 122 that may include a keyboard, a mouse, or any other device with which the user may input data. The display 124 displays data on a screen of the display 124. The display 124 may be a touch screen so that the display 124 can be used as the input device. Input device 122 may include a camera for capturing photos and/or videos.

The network interface 118 is used to communicate with other computing devices, wirelessly or via a wired connection. Through the network interface 118, any communications can be made between the server 110 and any other computing devices, such as travelers' computing devices or providers' computing devices.

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C#, Delphi, Fortran, Java, JavaScript, machine code, operating system command languages, Pascal, Perl, PL1, python, scripting languages, Visual Basic, meta-languages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

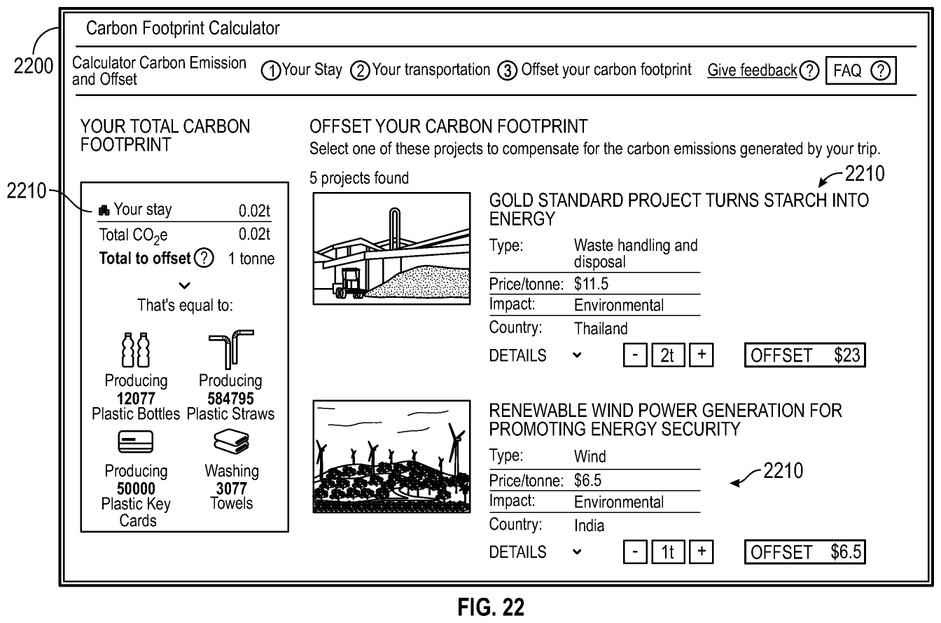

With continued reference to FIG. 1, the travel planning system 100 provides travel listings and listings management, a carbon footprint calculator (CFC) 132, and carbon offset projects (COPs) (see FIG. 22). The travel planning system 100 is configured to enable travelers to plan or view travel itineraries, book accommodations or transportation, reserve experiences (e.g., activities such as museums, cultural classes, or guided kayak tours), determine the carbon footprint of the travel itinerary via the CFC 132, and offset the net amount of carbon emissions due to their travel itinerary by contributing to a carbon offset project (COP). The CFC 132 determines and displays the carbon emissions footprint of a traveler's itinerary, and may be used before, during, or after travel. Additionally, the CFC 132 is configured to enable providers (e.g., a hotel or vacation home rental) to determine the carbon emissions for the various services offered (e.g., carbon emissions footprint of a hotel suite or standard room).

The travel planning system 100 prompts providers to submit listings data. Listings data includes accommodation type (e.g., hotel, motel, hostel, etc.); room data including room types (e.g., standard room, suites, king suites, etc.), number of each room type, and room size (unit area, e.g., 175 ft\hat{ }2); provider transportation information (e.g., hotel shuttle, golf carts, distance to/from transportation hubs); location data; and photos for each listing. Listings data may be for transportation services, including trains, airplanes, cruises, rental cars, etc., and may be identified by ticket tiers or classes (e.g., first-class, business class, or economy). The travel planning system 100 stores the listings data in a database so it may be displayed to a traveler.

The CFC 132 of the travel booking system prompts providers to submit carbon emissions data including the types of stationary fuels and mobile fuels used; type of refrigerants used for chillers or air-conditioners (AC); amount of electricity purchased or consumed from non-renewable sources, amount of steam, hot water, or district heating purchased, amount of cold water purchased (e.g., for cooling or refrigeration), and/or amount of laundry cleaned. The CFC 132 stores the carbon emissions data in a CFC database of the database 112, and relates the carbon emission information to the listings data.

The CFC 132 of this disclosure is also configured to calculate a carbon footprint of a travel itinerary or provider listing not only based on carbon emissions data and other listings data but also based on the carbon emissions required for providers to receive the materials or services that generate the carbon emissions ‘on site.’ The travel planning system 100 prompts providers to input the products used, where the products are sourced from (e.g., manufacturer, distributor, location), etc. to determine a carbon footprint of the materials and services that generate the carbon emissions ‘on site’. The CFC 132, using predefined parameters for each product, calculates the carbon emissions of those products and adds the result to the carbon emissions calculated from the aforementioned carbon emissions data, as described in detail below.

The travel planning system 100 is configured to enable travelers to plan a travel itinerary, including transportation, accommodations, and/or experiences. The travel planning system 100 may include an experiences database of sustainable experiences, activities, or ‘things-to-do.’

The travel planning system 100 enables travelers to plan and reserve transportation, accommodations, and/or experiences based on a desired carbon footprint. In aspects, the travel planning system 100 receives a desired carbon footprint and suggests transportation, accommodation, and/or experiences that is at or below the desired carbon footprint. For example, if a traveler inputs a carbon footprint limit of 3 metric tons of carbon emissions, the travel planning systems may show destinations with round trip flights that cause one metric ton of carbon emissions, accommodations with only 1 metric tons of carbon emissions, and experiences with only 1 metric tons of carbon emissions in total that would occur as a result of the traveler's plans. The travel planning system 100 includes an experience carbon footprint calculator that allows providers and travelers to estimate or predict the carbon footprint of any experience. The experience carbon footprint calculator may use pre-defined estimations of the carbon footprint of activities or may ask providers of experiences to answer a set of questions and input data related to their carbon footprint in order to determine the carbon footprint of the experience, for example, per person participating in the experience.

The travel planning system 100 may further be configured to determine and display real-time carbon footprints of providers' listings to travelers and/or providers. The real-time carbon footprints are determined by receiving real-time carbon emissions data (e.g., electricity usage data or mobile fuel data) via sensors monitoring carbon emissions data at the provider's facilities or services. Real-time carbon footprints may be based on real-time carbon emissions data and historical carbon emissions data. For example, if a traveler inputs a travel inquiry for accommodations into the travel planning system 100, the travel planning system 100 displays relevant accommodations (e.g., a hotel) and displays in real-time the carbon footprint of an individual staying in the hotel at that time.

The travel planning system 100 may further be configured to determine a food carbon footprint related to the food consumed at restaurants, snack bars, and other eateries on the trip. The travel planning system 100 may calculate the carbon footprint based on an image or scan of a receipt. The food carbon footprint is based on whether single use serving-ware or dinnerware (e.g., plates, bowls, forks, spoons, straws, etc.) and/or other kitchen or food related items (e.g., metal fork, napkins,) was used.

In aspects, the food carbon footprint is further based on where the food is sourced from (e.g., a sustainable farm or greenhouse), the manufacturing, packaging, and transportation of the food related items, and how preparation of the food affected its carbon footprint or its equivalent thereof (at the site of consumption, such as that due to refrigeration, grinding, cooking, baking, dishwashing, etc.). In other aspects, the travel planning system 100 determines a carbon emissions equivalent of the maintenance, cultivation, growing, processing, transportation, and/or preparation related to any restaurant or food related services to determine a food carbon footprint.

The travel planning system 100 may collect data relating to the food carbon footprint from the providers (e.g., via a hotel manager) or from suppliers (e.g., a wholesale restaurant distributor).

The travel planning application 130 is stored on memory 116 or database 112. The CFC 132 of the travel planning application 130, accesses the carbon emissions data, listings data, and COPs data, each of which are also stored on memory 116 or database 112. The provider UI 134, travel planning UI 136, and system administrator UI 138 are displayed on the display 124, and enable a traveler, provider, or system administrator to view, plan, or manage a travel itinerary, listings data or carbon emissions data.

With reference to FIG. 2, an exemplary functional block diagram of a travel planning system 100 illustrates traveler and provider interactions via the server 110. Travelers 210, via a computing device, such as a mobile device, may communicate with the server 110 via the traveler planning UI 136. The travel planning UI 136, via the travel planning application 130, accesses travel listings, CFC data, and COPs data. The traveler planning UI 136 receives a travel itinerary inquiry (e.g., a request to view provider listings based on a date range, location, or carbon footprint) and listing selection from the user.

The travel planning application 130 includes instructions stored on the memory 116 or database 112, which when executed by the processor 114, displays travel listings to the traveler 210, via the travel planning UI 136, based on the received travel itinerary inquiry. The travel planning application 130 enables the traveler to select a listing. The CFC 132 of the travel planning application 130 determines the carbon emissions footprint of the travel itinerary inquiry based on the selected listing, and the travel planning application 130 then displays the carbon emissions footprint of the travel itinerary (i.e., the selected listing). The travel planning application 130 is configured to display COPs a traveler may contribute to so that they may reduce their net carbon emissions footprint (see FIG. 22).

The provider UI 134 enables a provider 220 to input and create new listings, manage existing listings, manage carbon emission data related to new or existing listings, and manage booked listings or traveler itineraries.

The system administrator UI 138 enables a system administrator to manage listings data, carbon emission data and general carbon emission databases. The travel planning system may receive or process payments via a debit card, credit card, ECH, or other methods of payment (e.g., via Paypal® or Google Wallet®) as known by those of ordinary skill in the art in order to reserve or book an itinerary.

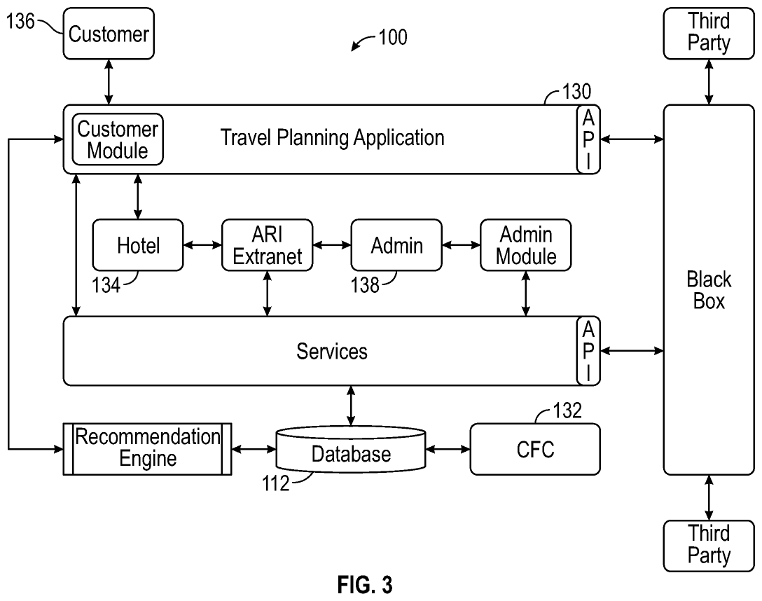

With reference to FIG. 3, another exemplary block diagram of a travel planning system of the present disclosure is shown. The travel planning application 130 accesses listings data, carbon emissions data, and COPs data stored on the database 112, and includes the traveler UI 136, provider UI 134, and system administrator UI 138.

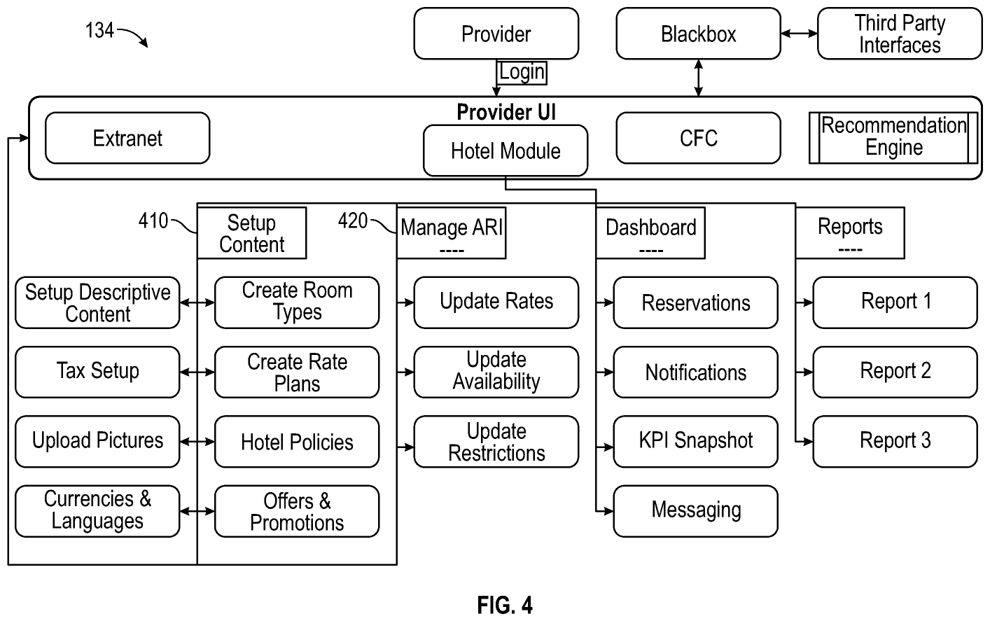

With reference to FIG. 4, a block diagram of a dashboard of the provider UI 134 of the travel planning system 100 is illustrated. The provider UI 134 enables the server to receive listings data and carbon emissions data from a provider. The provider UI 134 displays a listing setup interface 410 for managing listings data. A provider (e.g., a hotel) enters listings data via the input device 122 (e.g., a computer, keyboard, mouse, etc.). The listings data may include accommodation type offered, number of rooms, room size, amenities offered, bed types, photographs of the rooms or accommodations, etc. The provider UI 134 enables the server 110 to receive from the provider new listing data or edits to existing listing data, including listing rates, listing policies, offers and promotions, tax setups, acceptable currencies, and manage languages.

The provider UI 134 includes a management interface 420 that enables the provider to manage reservations, displays listing notifications, or communicate with a traveler or system administrator. The provider UI 134 may generate reports on listing bookings, traveler preferred rates, etc.

The provider UI 134 is configured to enable a provider to access the CFC 132 so as to determine the carbon footprint of potential travelers using a provider's services (i.e., the carbon footprint of a provider's listing such as a standard suite or king suite). The CFC 132 displays, via the display 124, the carbon footprint of each of the provider's listings. The CFC 132 may display carbon offset projects (COPs) so that providers may select and contribute to one or more COPs to reduce the net carbon emissions due to their listings. In aspects, the CFC 132 advises providers on the largest carbon emitting items (e.g., heating, air conditioning, electricity usage) of each listing, by displaying a total carbon footprint of each listing. Thus, providers are thereby equipped to determine what they can do to reduce their carbon footprint.

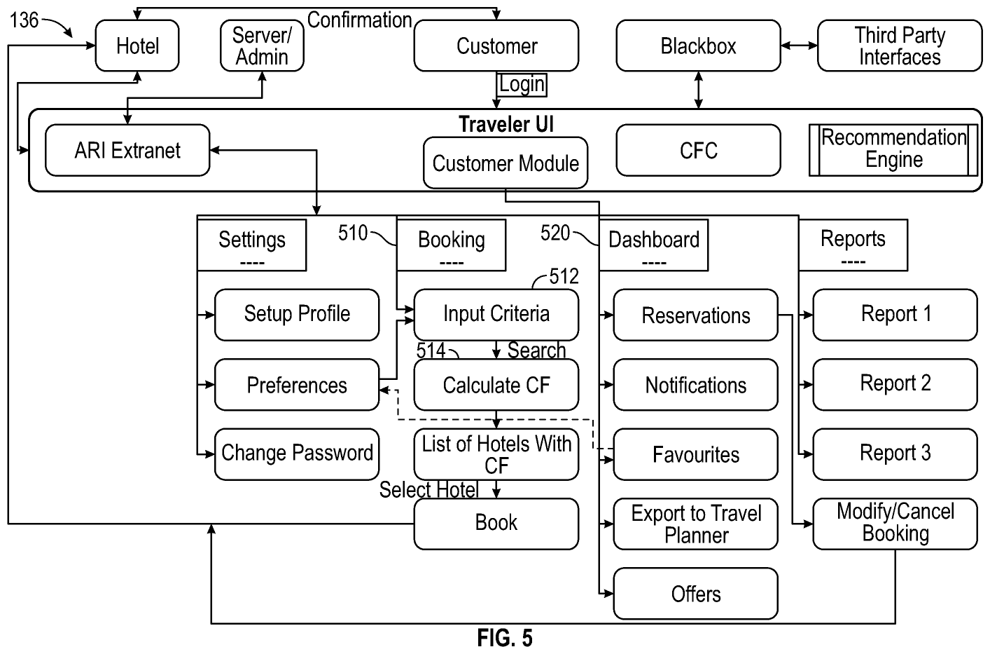

With reference to FIG. 5, a block diagram of an exemplary traveler UI 136 having a traveler dashboard is shown. A traveler 210 may create a traveler login including a username and password. The traveler UI 136 includes a booking interface 510 and an itinerary manager dashboard 520. The booking interface 510 includes a travel inquiry interface 512 and a CFC interface 514 that enables the traveler to provide an input to the CFC 132.

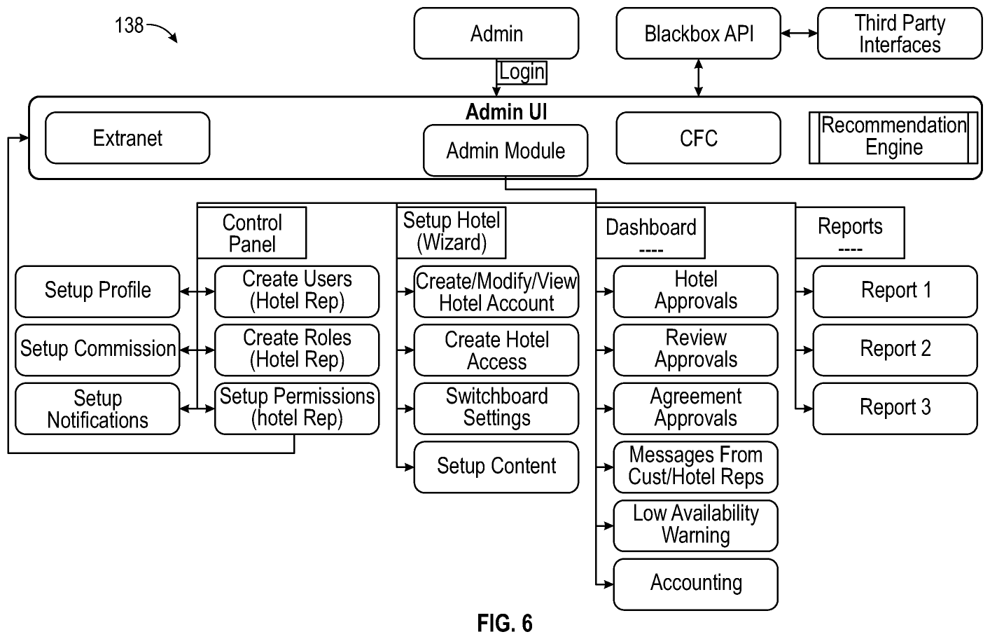

With reference to FIG. 6, a block diagram of an exemplary system administrator UI 138 may include an interface for managing providers (e.g., hostels, inns, motels), a reports interface configured to provide listings details and reservation history, and a carbon emissions interface configured to display a carbon footprint and/or display and receive carbon emissions data.

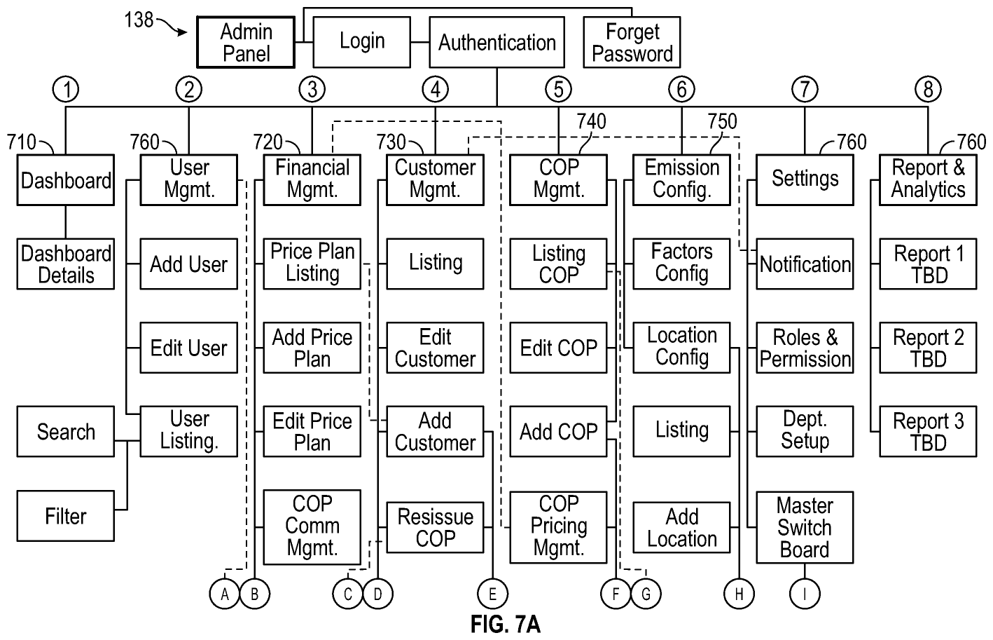

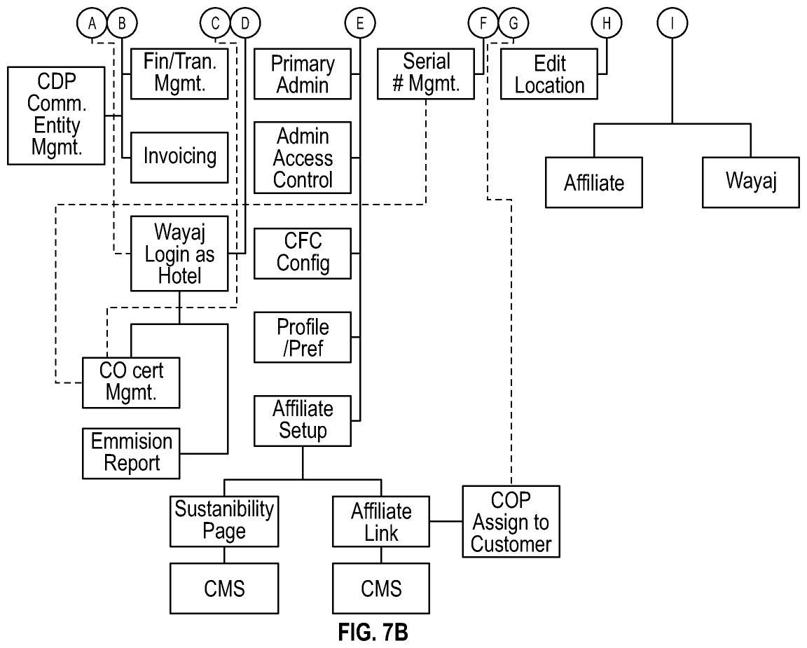

With reference to FIG. 7, another block diagram of an exemplary system administrator UI 138 is shown, and includes a dashboard 710, financial management interface 720, provider management interface 730, carbon offset project management interface 740, CFC management interface 750, and administrative interfaces 760. FIG. 7B is a continuation of FIG. 7A, and the lines connected to the encircled letters at the bottom of FIG. 7A correspond to the encircled letters at the top of FIG. 7B.

The financial management interface 720 is configured to enable a system administrator to update listing prices, listing price plans, COP price management, and general travel itinerary finance.

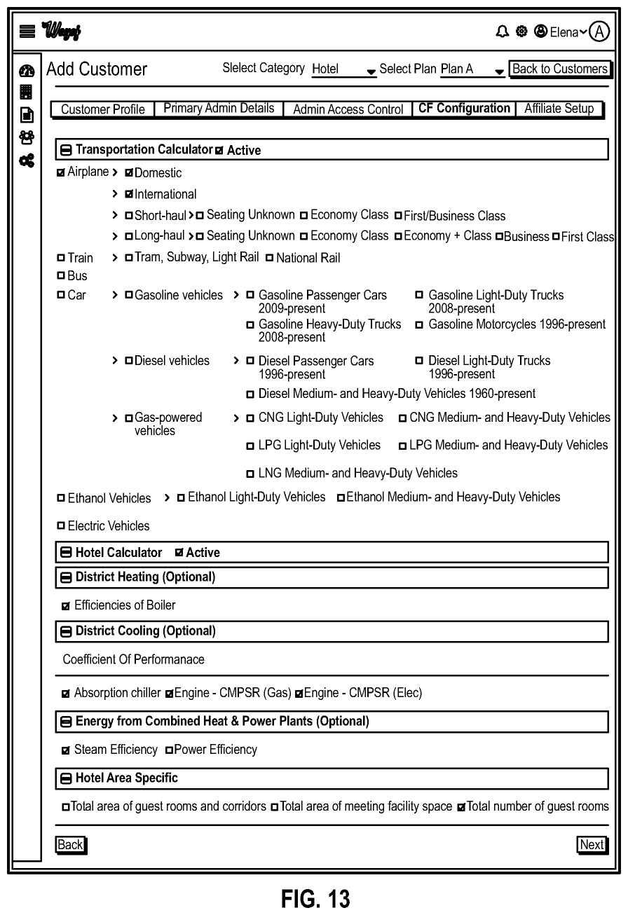

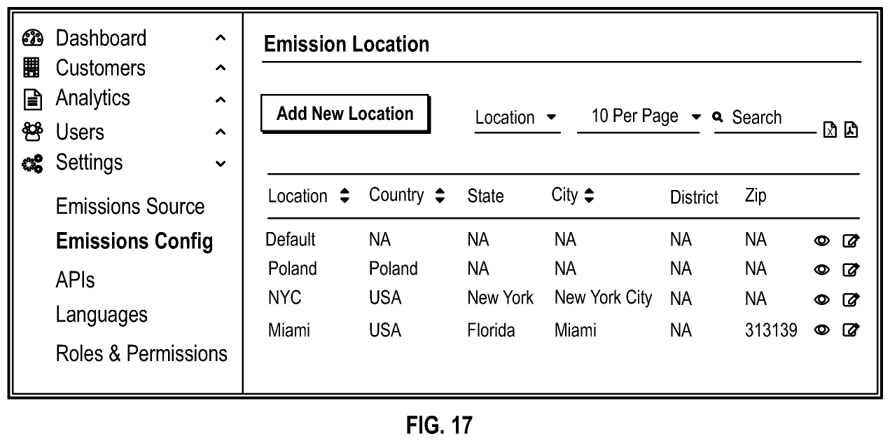

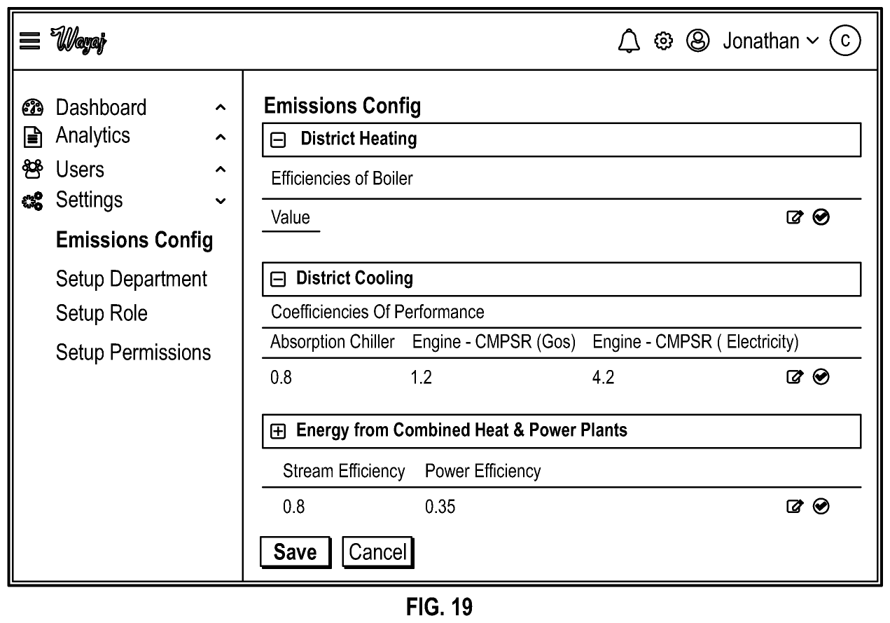

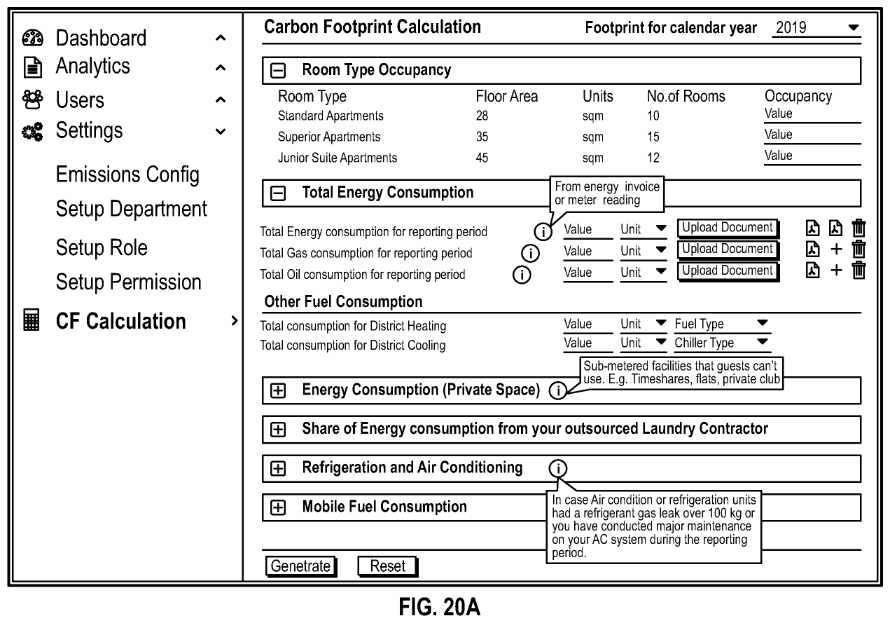

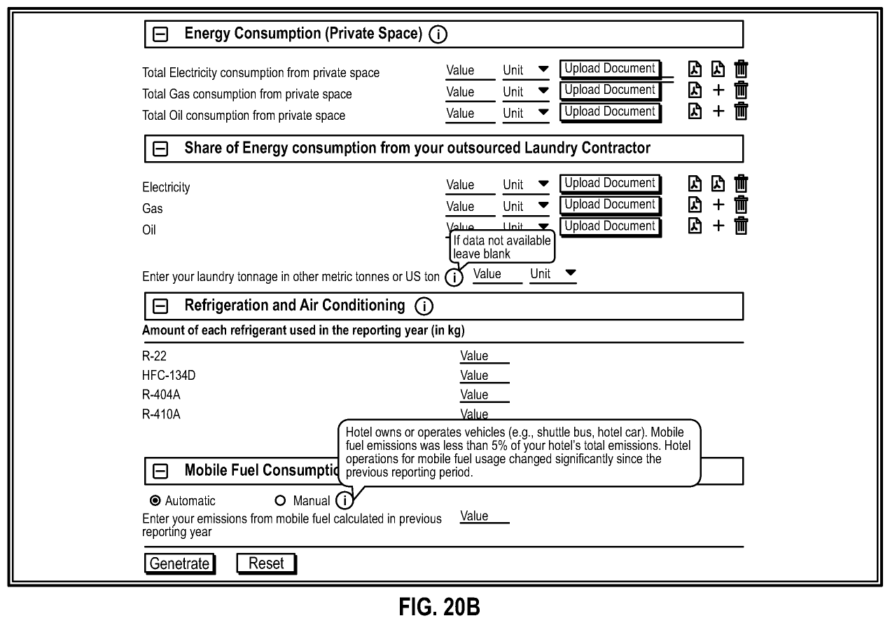

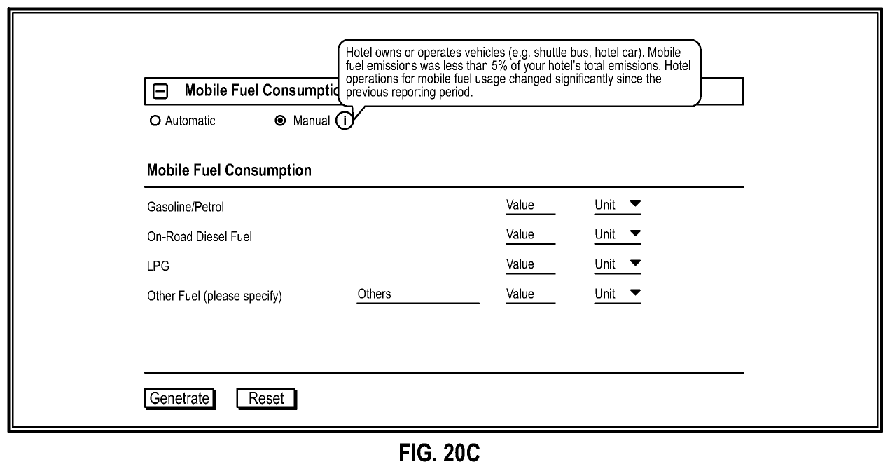

The provider management interface 730 is configured to enable a system administrator to add or update providers and provider logins, manage carbon offset projects purchased, and other managerial interfaces. The CFC management interface 750 includes interfaces for creating new or updating existing carbon emissions data, editing listings data, editing location data related to the carbon emissions data, and adding new provider listings, described and shown in more detail in FIGS. 13-20D.

The CFC 132 of the travel planning application 130, uses the carbon emissions data to determine a carbon footprint of a travel itinerary. Via the traveler UI 136, the travel planning system 100 receives a traveler's itinerary inquiry (e.g., request listings for dates and destination), which may include at least one of destination location (e.g., Paris, France), length of stay (e.g., 3 nights, 4 days), dates, mode of transportation (e.g., airplane, train, boat, etc.), selected provider (e.g., “Example Suites Hotel”). In aspects, the travel planning system 100 may display a list of providers and listings for the traveler to select. In other aspects, the travel planning system 100 displays only listings from a single provider. For example, if the travel planning system 100 is used by a web interface of Example Suite Hotel's own servers, the travel planning system only displays Example Suite Hotel's listings available based on the travel inquiry criteria.

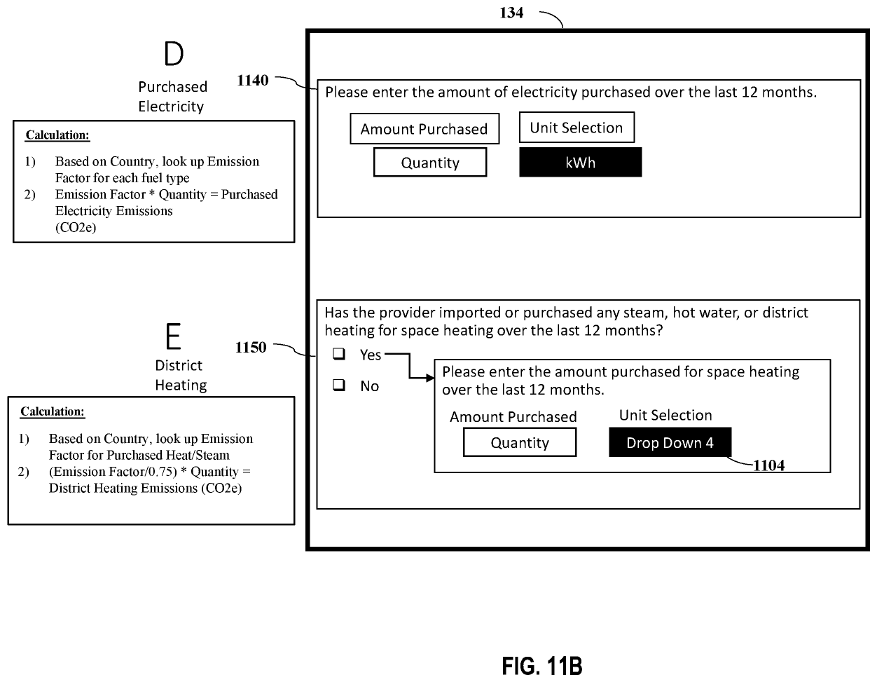

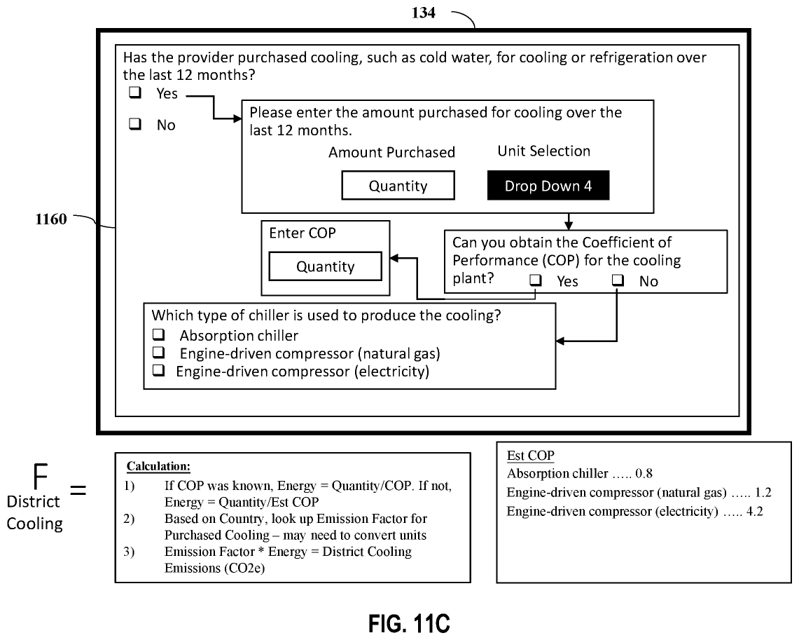

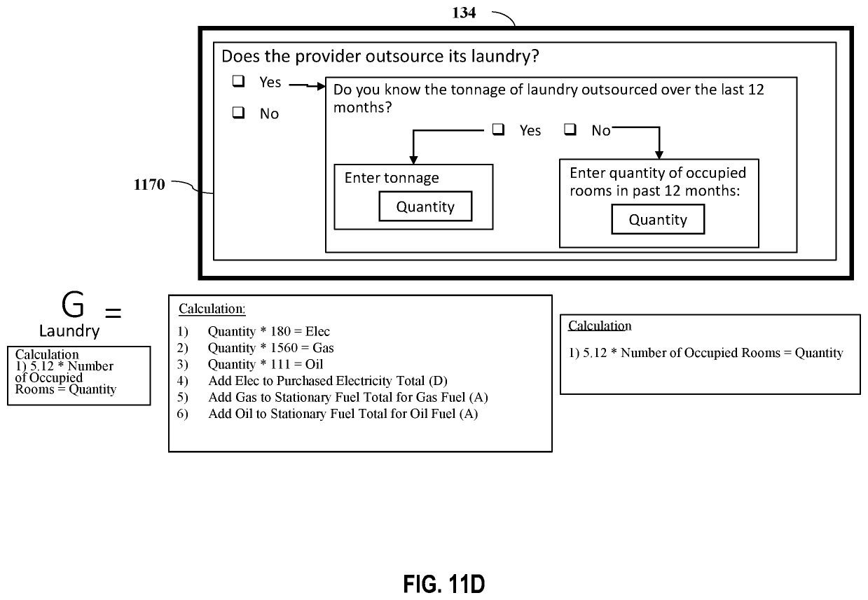

The travel planning system 100 receives a traveler's listing selection or travel inquiry, and the CFC 132 determines the carbon footprint of the listing selection, (see FIGS. 11A-D and 12). The CFC 132 accesses the carbon emissions data and listings data stored in the database 112 or memory 116.

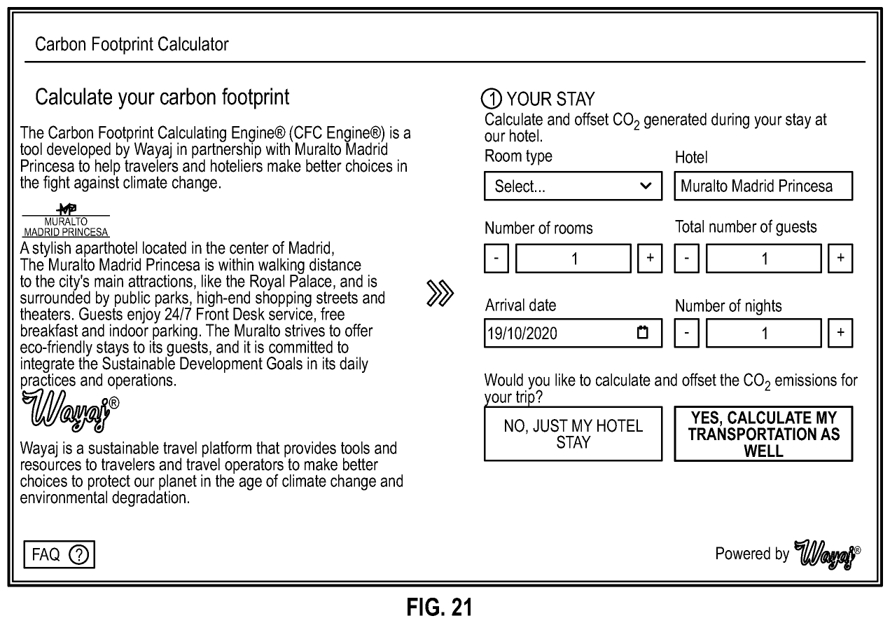

The travel planning system 100 displays the determined carbon emissions footprint from the CFC 132, and displays COPs a traveler may contribute to, as discussed below with reference to FIGS. 21 and 22.

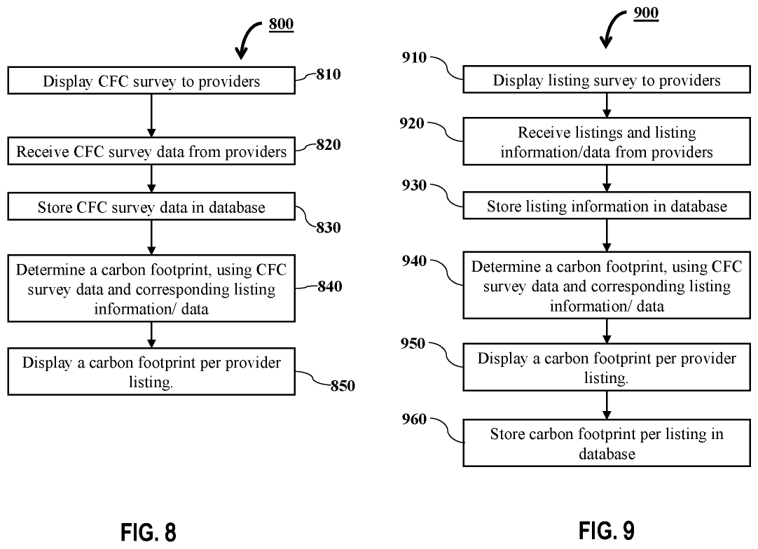

With reference to FIGS. 8-10, methods for providing travel itineraries, carbon emission footprints of the travel itineraries, and carbon offset projects (COPs) to reduce the net carbon emission footprint of a traveler are illustrated.

Persons skilled in the art will appreciate that one or more operations of the method 800, 900, and 1000 shown in FIGS. 8-10, respectively, may be performed in a different order, repeated, and/or omitted without departing from the scope of the disclosure. In various aspects, the illustrated methods 800, 900, and 1000 can operate in server 110 (FIG. 3), in a remote device, or in another server or system. Other variations are contemplated to be within the scope of the disclosure. The operations of methods 800, 900, and 1000 will be described with respect to a server, such as that shown in (FIG. 1), but it will be understood that the illustrated operations are applicable to other systems, computers, and components thereof as well.

The disclosed methods 800, 900, 1000 may be executed when a person passes through/by the system of FIG. 1.

With reference to FIG. 8, a method 800 for determining a carbon footprint of a provider listing includes displaying a carbon emissions survey to the providers at step 810. The carbon emissions survey enables a provider to input carbon emissions data related to the provider's listings. At step 820, the method 800 receives the input to the carbon emissions survey data from the provider. At step 830, the method 800 stores the carbon emissions survey data in the database 112. At step 840, the method 800, via the CFC 132, determines a carbon footprint based on the received carbon emissions survey data and corresponding listing information/data stored in the database 112. At step 850, the method 800 displays the carbon emissions footprint per provider listing determined in step 840.

With reference to FIG. 9, a method 900 for determining a carbon footprint of a provider listing includes a step 910 of displaying a listing survey to a provider. During step 910, the method 900, via the travel planning system, may prompt providers to input details related to their listings, such as room types, number of rooms, room size, etc. At step 920, the method 900 receives listings data from the providers, and at step 930 the method 900 stores the listings data in the database 112. At step 940, the method 900, via the CFC 132, determines a carbon footprint based on the received listing data and corresponding carbon emissions data stored in the database 112. At step 950, the method displays the carbon emissions footprint per provider listing determined in step 940.

Methods 800 and 900 for determining a carbon footprint of a provider listing enables providers to tailor their services, marketing plans, and understand their carbon emissions so that they may reduce their net carbon footprint. Additionally, methods 800 and 900 enable the travel planning system 100 to store listings and associated carbon footprints so that it may display the listings and associated carbon emission footprints to travelers planning to travel or who have already traveled.

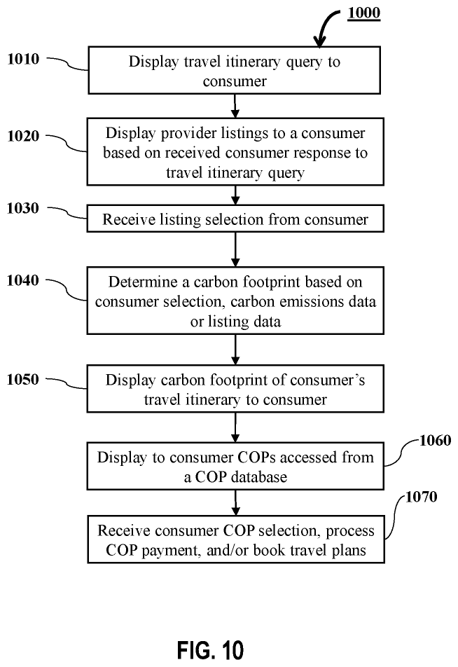

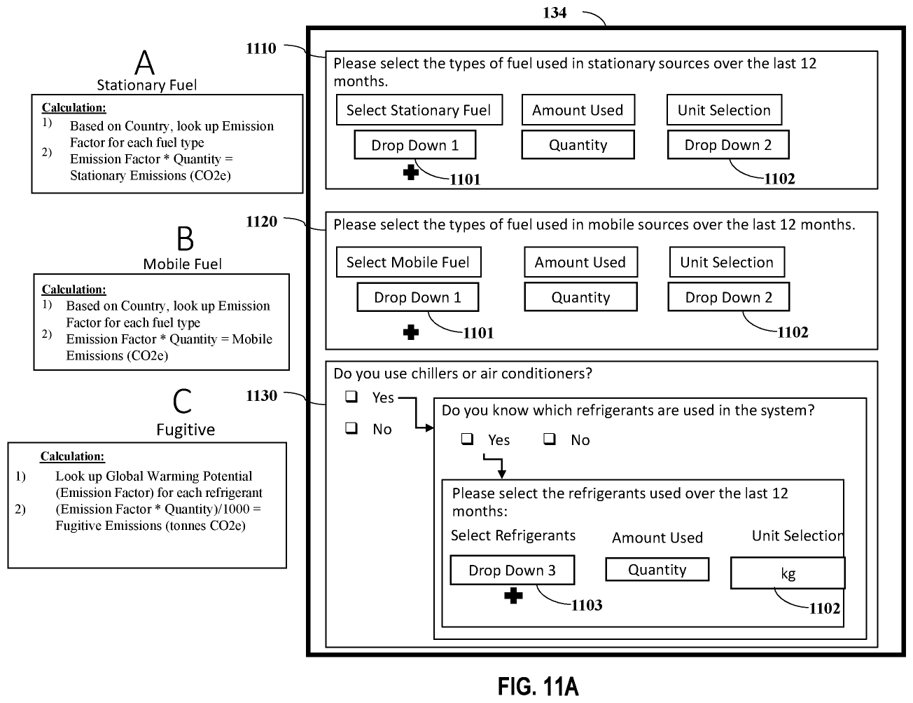

With reference to FIG. 10, a method 1000 for providing carbon emission footprints of a travel itinerary and/or book the travel itinerary is illustrated. At step 1010, the method displays, via the travel planning system 100, a travel plan survey to a traveler 210. At step 1010, the method displays a travel itinerary inquiry (e.g., a questionnaire for desired or planned travel) requesting input. The input may be desired travel dates, destination locations, preferred providers, and/or listing types, etc., as discussed above. In aspects, at step 1010, the method receives a response (i.e., the input to the travel itinerary inquiry). At step 1020, the method displays provider listings to the traveler based on the received response to the travel inquiry. Provider listings may be for hotel rooms, hostel rooms, vacation home rentals, cruise rooms/tickets, plane tickets, etc. At step 1030, the method receives a provider listing selection from the consumer based on the listings displayed at step 1020. At step 1040, the method, via the CFC 132 of the travel planning system 100, determines a carbon footprint for the selected travel itinerary inquiry based on listing data and carbon emissions data stored in the database 112 that corresponds to the travel itinerary inquiry. At step 1050, the method displays to the traveler the carbon emissions footprint of the traveler's selected travel itinerary determined in step 1040. At step 1060, the method accesses carbon offset projects (COPs) data stored in the database 112 and displays to the traveler the COPs. At step 1070, the method receives a COPs selection based on the COPs displayed at step 1060, processes a payment for the travel itinerary, and/or processes payment for a contribution to a selected COP.

With reference to FIGS. 11A-D and 12, the CFC 132 determines the carbon emissions footprint in steps 840, 940, and 1040 by adding together carbon emission factors based on the carbon emission data and listing data obtained in steps 820 and 920. Carbon emission factors (described in detail below) are represented in terms of carbon dioxide equivalents, or the number of metric tons of carbon dioxide emissions with the same global warming potential that would be due to one metric ton of another greenhouse gas or emission source. For example, the carbon emissions equivalent due to 10 kilowatt hours of electricity used by a provider listing (e.g., a cabin) may be added to the carbon emissions equivalent due to 15 liters of natural gas used (e.g., used by a boiler or oven in the cabin) to obtain the total carbon emissions footprint of the cabin by representing each in terms of a carbon emissions equivalent (CO2e). In the example, the 10 kilo-watt hours of electricity used may be equivalent to 0.75 tons of CO2e and the 15 liters of natural gas may be equivalent to 0.25 tons of CO2e, for a total of one-ton CO2e. If the cabin also included a washer that emitted a pollutant with a global warming potential equal to 0.10 tons of CO2e, then the total carbon emissions equivalent would be 1.10 tons of CO2e. FIGS. 11A-D and 12 are exemplary provider UIs 134 that may be displayed in steps 810 and 910 for receiving the carbon emission and listing data. In addition to carbon emissions data received from a provider, the database 112 stores global carbon emission data and factors for various geographical locations, as detailed below, that is accessed by the CFC 132.

The travel planning system 100 may collect carbon emissions data via sensors and carbon and energy monitoring devices at the providers facilities. The sensors and monitoring devices include water meters, gas meters, electricity meters, air quality sensors, temperature sensors, appliance run time sensors, occupancy sensors (e.g., for hallways, elevators, public bathrooms), cleaning or housekeeping trackers (e.g., counting the number of times cleaning staff enter rooms), pool heaters and cleaner sensors, boiler sensors, etc. The data is collected by the travel planning system 100 from the provider who inputs the data into the travel planning system 100. The travel planning system 100 uses the measured data to provide real time and accurate carbon footprint determinations. The travel planning system 100 may connect to provider management systems to keep track of occupancy, future reservations, event reservations, energy services and billing, etc. Utility information may be synced with the travel planning system 100 so the CFC 132 may update the carbon footprint on a rolling basis and create time/historical charts to show the carbon footprint over time per occupancy rates, event rates, holiday periods, and the like. The CFC 132 may analyze past utility or energy data submitted to determine carbon footprints of past travel itineraries.

The CFC 132 is configured to generate reports of providers' listings (e.g., rooms or suites usage) and the associated fluctuating carbon footprint to the providers. The CFC 132 may suggest areas of improvement or products that may help reduce providers' or travelers' carbon footprints based on the collected carbon emissions data.

Referring again to FIGS. 11A-D and 12, an exemplary provider UI includes drop down lists of items 1101, 1102, 1103, and 1104, that when selected, display a corresponding list.

Drop down list 1101 displays a list of fuels including: Natural Gas, Butane, Propane, Liquefied Petroleum Gas (LPG), Liquefied Natural Gas (LNG), Compressed Natural Gas (CNG), Stationary Gasoline/Petrol, Stationary Diesel, Fuel Oil #1, Fuel Oil #2, Fuel Oil #3, Fuel Oil #4, Fuel Oil #5, Fuel Oil #6, City Gas/Town gas, Charcoal, Kerosene, and Ethanol. Any fuel known by those of ordinary skill in the art may by displayed by drop down list 1101. Drop down list 1102 displays a list of unit options including: gigajoules (GJ), kilo-watt hours (kWh), thermal unit (therm), kilocalories (Kcal), million British Thermal Units (MMbtu), liters (L), cubic meters (m\hat{ }3), cubic feet (ft\hat{ }3), gallon (gal), barrels (bbl), kilograms (kg), tons (t), and pounds (lbs). Any unit known by those of ordinary skill in the art may by displayed by drop down list 1102. Drop down list 1103 displays a list of fugitive refrigerants including, but not limited to, R-22, HFC-134a, R-404A, and R-410A. Any refrigerant known by those of ordinary skill in the art may by displayed by drop down list 1103. Drop down list 1104 displays a list of units including: GJ, kWh, therm, Kcal, and MMbtu.

As illustrated in FIG. 11A, the travel planning system 100, via a stationary fuel UI 1110 of the provider UI 134, receives stationary fuel consumption data inputted by a provider who selects a stationary fuel from the drop down list 1101, inputs the amount used, and selects a unit for the amount from drop down list 1102. Stationary fuel is fuel that is used by a stationary item, such as a boiler. The stationary fuel UI 1110 enables a provider to enter any number of stationary fuels. The CFC 132 determines a stationary fuel emissions total A by multiplying the quantity of each stationary fuel received by a fuel emissions factor for that fuel type and unit stored in the database 112 and summing the products, as illustrated by equation (1):

(Fuel Emissions factor×quantity)+ . . . (Fuel Emissions factor n×quantity n)=stationary fuel emissions total A (CO2e) (equation 1)

A fuel emissions factor is an equivalent amount of carbon emitted per a single unit of a specified fuel. In the equation, and those that follow, “n” represents each additional entry.

For example, if the provider inputs 100 cubic feet of natural gas for which the emissions factor may be, for example, 0.0549 kg of carbon dioxide emissions equivalent (CO2e) per cubic foot, the stationary emissions A would be 5.49 kg of CO2e. If the provider also input 500 gallons of Fuel oil #2 for which the emissions factor may be, for example, 10.21 kg of CO2e per gallon, the stationary emissions of which are 5,105 kg of CO2e, the stationary fuel emissions total A would be 5,110.49 kg of CO2e.

In aspects, the CFC 132 of this disclosure may determine the carbon emissions consumed in the manufacturing and transportation of the fuels consumed. For example, the CFC factors in the carbon emissions related to manufacturing of a gasoline or oil and the carbon emissions related to transporting the gasoline or oil to a power plant. The CFC 132 determines the carbon emissions related to fuel and energy-related activities including extracting raw materials for fuel, processing the raw materials, losses due to electricity generation, or electricity transmission losses. Different defaulted factors or reported values may be used to calculate the carbon footprint of those activities. The CFC 132 accounts for varying locations and efficiencies of the provider. The resulting carbon emissions may be added to the emissions total A. Thus, travelers are able to have a broader and more accurate determination of the ‘true’ carbon footprint related to their travel plans.

The travel planning system 100, via a mobile fuel UI 1120 of the provider UI 134, receives mobile fuel consumption data inputted by a provider who selects a mobile fuel from the drop down list 1101, inputs the amount used and selects a unit for the amount from drop down list 1102. Mobile fuel is fuel that is used by a mobile unit, such as a provider van, shuttle or automobile. The mobile fuel UI 1120 enables a provider to enter any number of mobile fuels and amounts used. The CFC 132 determines a mobile fuel emissions total B by multiplying the quantity of each mobile fuel received by a fuel emissions factor for that fuel type stored in the database 112 and summing the products of each mobile fuel received, as illustrated by equation (2):

(Fuel Emissions factor×quantity)+ . . . +(Fuel Emissions factor n×quantity n)=mobile fuel emissions total B (CO2e) (equation 2)

The travel planning system 100, via a fugitive emissions UI 1130 of the provider UI 134, receives fugitive emission data (i.e., refrigerant consumption or leaks) inputted by a provider who selects a refrigerant from the drop down list 1103 and inputs the amount in kilograms used. A fugitive is a refrigerant or similar item used in air conditioning or chiller systems, and fugitive emissions are those associated with refrigerants that have escaped, leaked or otherwise removed from air conditioning, chiller systems, or any other device or system that uses a refrigerant. The fugitive emissions UI 1130 enables a provider to enter any number of refrigerants and amounts used. The CFC 132 determines a fugitive emissions total C by multiplying the quantity of each refrigerant received by a fugitive emissions factor, or the global warming potential (GWP) (a value used to convert refrigerants to an equivalent amount of CO2e), for that refrigerant type stored in the database 112 and summing the products, as illustrated by equation (3):

((GWP×quantity)/1000)+ . . . +((GWP n×quantity n)/1000)=Fugitive emissions total C (tons (t) of CO2e) (equation 3)

A fugitive emissions factor is an equivalent amount of carbon that would be emitted per a single unit of a refrigerant or fugitive. In aspects, a provider may also select a unit for the amount used from drop down list 1102, and equation 3 would be modified to account for an appropriate denominator (i.e., a divisor other than 1000—there are 1000 kg in a metric ton).

With reference to FIG. 11B, the travel planning system 100, via an electricity emissions UI 1140 of the provider UI 134, receives electricity usage data from a provider. The provider inputs the amount of electricity used or purchased. In aspects, the provider may select a unit for the amount of electricity used or purchased from drop down list 1102 if the unit is not in kWh. The CFC 132 determines an electricity emissions total D by multiplying the quantity of electricity used or purchased by an electricity emissions factor based on the provider's region or utility servicer stored in the database 112, as illustrated by equation (4):

(Electricity emissions factor×quantity)=Electricity emissions total D (CO2e) (equation 4)

An electricity emissions factor is the amount of carbon emitted per an amount of fuel required to generate a unit of electricity, and varies depending on the source of the electricity, since various fuels may be used in the production of electricity.

With continued reference to FIG. 11B, the travel planning system 100, via a district heating emissions UI 1150 of the provider UI 134, receives an amount of district heating purchased input by a provider. The CFC 132 determines a district heating emissions total E by multiplying the quantity of district heating purchased by a district heating emissions factor based on the provider's region stored in the database 112 that is divided by 0.75, as illustrated by equation (5):

((district heating emissions factor/0.75)×quantity)+ . . . +((district heating emissions factor n/0.75)×quantity n)=district heating emissions total E (CO2e) (equation 5)

A district heating emissions factor is the equivalent amount of carbon emitted per a unit of district heating, hot water, or steam, and varies depending on the source of fuel used to produce the district heating, hot water or steam.

With reference to FIG. 11C, the travel planning system 100, via a district cooling emissions UI 1160 of the provider UI 134, receives an amount of district cooling purchased that is input by a provider. District cooling is the distribution of cooling energy from a centralized plant to several buildings in a district for room air conditioning or refrigeration, and may be provided, for example, via cold water pumped into a building. The travel planning system 100, in addition to the amount of cooling purchased, may prompt a provider to input a coefficient of performance of the cooling plant used by the district cooling distributor. The coefficient of performance is a ratio of the energy that came out of a system, such as a district cooling system, divided by the energy that went into the system. If the coefficient of performance is not known, the travel planning system may prompt the provider to input the type of district cooling system (chiller) used, such as an absorption chiller, engine-driven compressor using a fuel source (e.g., natural gas), or an engine drive compressor using electricity. An average or value of the coefficient of performance of various district cooling systems is stored in the database. For example, the average coefficients of performance of an absorption chiller, engine driven compressor using a fuel source, and an engine driven compressor using electricity are 0.8, 1.2, and 4.2, respectively.

The CFC 132 determines a district cooling emissions total F by first determining if a coefficient of performance has been received or stored in the database 112 by accessing listing data and carbon emissions data stored in the database 112 that may use the same district cooling system. The CFC 132 then determines the amount of energy used by the district cooling system by dividing the amount of district cooling purchased by the coefficient of performance input or stored in the database 112, or if unavailable, by the average coefficient of performance of the type of district cooling system used. The CFC 132 then determines a district cooling emission total F by multiplying the energy by a district cooling emission factor, as illustrated by equation (6):

(district cooling emissions factor×quantity)+ . . . +(district cooling emissions factor n×quantity n)=district cooling emissions total F (CO2e) (equation 6)

A district cooling emissions factor is the equivalent amount of carbon emitted per a unit of district cooling, and varies depending on fuel used to generate the district cooling.

With reference to FIG. 11D, the travel planning system 100, via a laundry UI 1170 of the provider UI 134, receives an amount of laundry by weight outsourced by a provider to a laundering service. If the amount of laundry by weight is not known, a provider may be prompted to input the number of occupied rooms from the most recent 12 months at the time of input. The number of occupied rooms is then multiplied 5.12 to provide an estimated amount of laundry by weight (or multiplied by any other predetermined value to determine the laundry by weight). In aspects, if the provider cleans its own laundry the carbon emissions would be included in the amount of electricity or amount of stationary fuel purchased or used. The CFC 132 determines the total amount of electricity due to the outsourced laundry G₁ by multiplying the amount or estimated amount of laundry by weight (tons) by 180 and adding the product to the electricity emissions total D. The CFC 132 determines the total amount of gas consumed due to the outsourced laundry G₂ by multiplying the amount or estimated amount of laundry by weight (tons) by 1560 (or multiplied by any other predetermined value to determine a stationary fuels emissions due to the outsourced laundry) and adding the product to the stationary fuel emissions total A. The CFC 132 determines the total amount of oil consumed due to the outsourced laundry G₃ by multiplying the amount or estimated amount of laundry by weight (tons) by 111 (or multiplied by any other predetermined value to determine a stationary fuels emissions due to the outsourced laundry) and adding the product to the stationary fuel emissions total A. Based on how the provider cleans its own laundry, a total emissions due to laundry G may be determined.

In aspects, the CFC 132 may further determine the carbon emissions due to guests personal laundry (e.g., dry cleaning a suit or washing a dress). The CFC 132 adds the carbon emissions due to guests personal laundry, for example, by calculating the number of loads of laundry washed by a guest washing machine at the provider hotel. The provider may include in its listing data the number of washing machines on site for guest use, the make and models (which the CFC associates to a carbon emissions factor), and the number of times that washing machine is used per year. The CFC 132 may, instead of adding the carbon emissions of guest laundry, display the carbon emissions that would be consumed by the traveler if used to the traveler. In aspects, the CFC 132 may similarly determine the carbon emissions due to guests personal laundry cleaned at a laundromat or dry-cleaning facility off site from the provider.

In aspects, units input by the provider may be converted into different units before performing any determination, in accordance with common practice for converting units known to those of ordinary skill in the art. For example, if the provider inputs 1,728,000 cubic inches of natural gas, that may be converted to 1 cubic foot of natural gas for which the emissions factor may be, for example, 0.0549 kg of carbon dioxide equivalent emissions (CO2e) per cubic foot, the stationary emissions A would be 5.49 kg of CO2e.

The CFC 132 determines a total carbon footprint (TCF) by summing, according to equation 7, the stationary fuel emissions total A, a mobile fuel emissions total B, fugitive emissions total C, electricity emissions total D, district heating emissions total E, and district cooling emissions total F to determine the total carbon footprint of all of that providers locations' listings.

A+B+C+D+E+F=TCF (equation 7)

In aspects, the TCF may also include a food carbon emissions total H (e.g., based on the food carbon emissions described above) and a miscellaneous total carbon emissions factor M. The miscellaneous total carbon emissions factor M includes the carbon emissions (or equivalent thereof) due to the manufacture and transportation of other items or goods consumed or produced by the provider (e.g., due to the production of blankets or furniture used by a provider, or due to the water consumed by the facility), and may include any other carbon emissions (or equivalents thereof) described herein. Thus, the TCF may be calculated according to equation 7.1.

A+B+C+D+E+F+H+M=TCF (equation 7.1)

In aspects, if the fuel or refrigerant is unknown, the TCF is determined by the CFC 132 by summing the stationary fuel emissions total A, the mobile fuel emissions total B, the electricity emissions total D, the district heating emissions total E, and the district cooling emissions total F, and multiplying the sum by 1.01 (or any other predetermined value for accounting for the unknown fuel or refrigerant), according to equation 8:

(A+B+D+E+F)×1.01=TCF (equation 8)

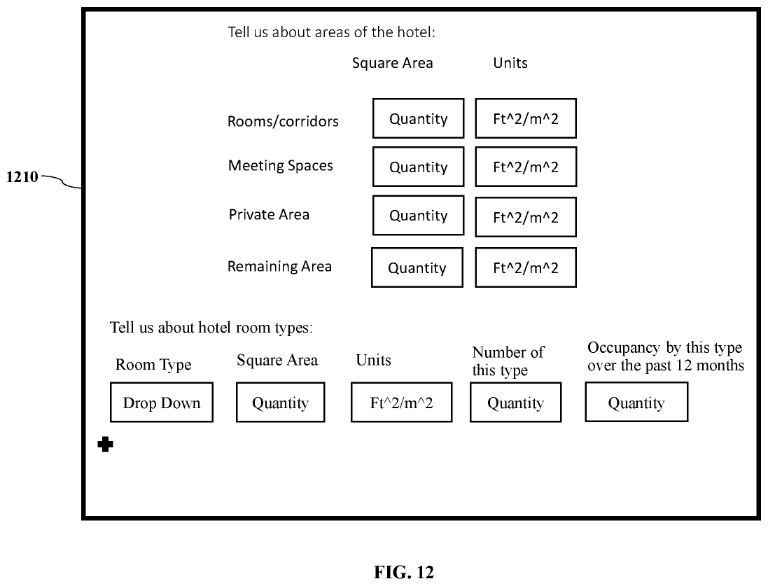

With reference to FIG. 12, the travel planning system 100, via an exemplary listings UI 1210 of the provider UI 134, prompts a provider to input property data of the listings data including the number and types of rooms or spaces of the provider's property and the square footage of each room or space, including accommodation rooms and corridors, meeting spaces and conference rooms, private areas (e.g., yearly leased apartments or condominiums), and remaining areas not explicitly provided for. The travel planning system 100 also prompts the provider to input the occupancy of each room type over the past 12 months as of the time of input. The provider may update the listings data, including any of the property data, at any time via the provider UI 134.

The CFC 132 determines a carbon footprint of each listing (e.g., a room) offered by a provider to travelers using the listings data, carbon emissions data, and the TCF. The CFC 132 determines the total listings area by summing the total accommodation or corridor areas, meeting areas, private areas, and remaining areas. The CFC then determines the percentage each area occupies of the total listings area by dividing each area by the total listings area in accordance with equations 9A-9D:

% Room area=(Rooms/Corridor Area)/Total area (equation 9A)

% Meeting area=(Meeting Area)/Total area (equation 9B)

% Private area=(Private Area)/Total area (equation 9C)

% Remaining area=(Remaining Area)/Total area (equation 9D)

The CFC 132 determines an allotted carbon footprint (ACF). The allotted carbon footprint is the carbon footprint of the listings areas that are open to the travelers while staying at the provider's property (i.e., all but the private areas). The CFC 132 subtracts the product of the TCF and the percentage of the private area from the TCF as illustrated by equation 10:

ACF=TCF−(TCF×% Private area) (equation 10)

The CFC 132 determines a percent allotted to rooms by dividing the rooms and corridor areas by the sum of the room and corridor areas and the meeting and conference areas, as illustrated by equation 11:

% Allotted to rooms=(rooms and corridor area)/((rooms and corridor area+meeting and conference area)) (equation 11)

The CFC 132 determines a percent allotted to meeting and conference areas subtracting the percent allotted to rooms from 1, as illustrated by equation 12:

% Allotted to Meetings=(1−% Allotted to Rooms) (equation 12)

The CFC 132 determines a total rooms and corridors carbon footprint (TRCCF) by multiplying the % Allotted to rooms by the ACF, as illustrated by equation 13:

TRCCF=% Allotted to Rooms×ACF (equation 13)

To determine the carbon footprint of each room type of a listing, the CFC 132 determines a total area of each room type by multiplying the number of each room type by the area of that room type. A percent area by room type is determined by dividing the total area of each room type by the total listings area. The carbon footprint of each room type for a 12 month period is determined by multiplying the percent area by room type by TRCCF. The carbon footprint of each room type per night is determined by dividing the carbon footprint of each room type for a 12 month period by the occupancy of that room type.

Alternatively, the CFC 132 may determine the carbon footprint of the total area of a provider's premises (CFTA) (e.g., including room area, private area, public area, meeting area, etc.) by dividing the TCF by the total area (CFTA=TCF/total area), and then determine the carbon footprint per hour of the total area by dividing the CFTA by an amount of time, (e.g., days, hours, minutes, etc.). The CFTA may be divided by 8760, or the number of hours in a year.

The travel planning system 100 may prompt a provider, via the display to input an amount of time (e.g., days, hours) that the meeting areas are occupied for or input the annual number of meetings in the meeting area which may be multiplied by a predetermined average duration of meetings in the meeting area to obtain the amount of time that the meeting areas are occupied for. The travel planning system 100 may additionally prompt the provider to input an amount of time needed for setting up and cleaning up the meeting area per each meeting. The CFC 132 may then determine the total time each meeting area is occupied for by summing the amount of time needed for setting up and cleaning up with the amount of time each meeting area is occupied for. The CFC 132 then determines the percentage of the total meeting room areas each meeting room occupies and the CFC 132 multiplies the result by total time each meeting area is occupied for to get the carbon footprint per meeting area per hour. The CFC 132 may determine an amount of carbon emissions due to food preparation, materials used, or other carbon emissions associated with use of the meeting areas and include that in the carbon footprint per meeting area per hour.

The CFC 132 determines the total amount of time the total meeting areas are occupied for (or prompts the provider to input the total amount of time the total meeting areas are occupied for,) and multiplies the result by the carbon footprint per area per hour to obtain a meeting area carbon footprint per unit area of the meeting areas (e.g., per square foot or square meter). The CFC 132 multiplies the meeting area carbon footprint per unit area of the meeting areas by the total area of the meeting areas to get a total carbon footprint of the meeting areas. The CFC 132 subtracts the total carbon footprint of the meeting areas from the TCF to obtain the total carbon footprint minus the meeting areas (TCFMMA).

The CFC 132 multiplies the total area of the private areas by the CFTA to obtain the total carbon footprint of the total area of the private areas (TPACF or total private area carbon footprint). The CFC 132 subtracts the TPACF from the TCFMMA to get the total carbon footprint remaining (TCFR). The CFC 132 may then use the TCFR to determine the carbon footprint of each room as follows. The CFC 132 determines a occupied area of each room type (OAER) by multiplying the annual number of occupied nights per room type (as estimated or input by a provider) by the area of each room type. The CFC 132 determines a share of each room type (SERT) by dividing the OAER by the sum of the occupied area for all room types. The CFC 132 then determines a total annual carbon footprint per room type (TACFPR) by multiplying the SERT by the TCFR. The CFC 132 then determines the carbon footprint per room per night per room type by dividing the TACFPR by the total occupied nights of each room of each room type.

The CFC 132 may calculate the amount of water used by the provider and by each room type. The CFC 132 calculates the amount of carbon emissions emitted by the water sanitation and purification plant or utility that produces the water used by the provider. The CFC 132 may add the carbon emissions of the water to the total carbon footprint (TCF). The CFC 132 may determine water usage per specific room, where rooms vary in the number and types of sinks, bathtubs, showers, or jetted tubs that may be included.

The CFC 132 determines the carbon footprint of each room type per night for each listing in any of the manners described above. When a traveler selects a listing, the CFC 132 multiplies the number of nights requested to stay at that listing by the carbon footprint of each room type per night for that listing to determine a travel itinerary carbon footprint, and displays the travel itinerary carbon footprint to the traveler. In aspects, the CFC 132 calculates the carbon footprint based on the occupancy of each room during a period of time (e.g., a year). The CFC 132 may calculate the carbon footprint based on the predicted occupancy of the provider's listings at the intended travel date and time. For example, the CFC 132 may determine that higher occupancy over a holiday period may be greater, leading to a lower carbon footprint per person at that time (since, for example, communal areas requiring lighting has a carbon footprint that is distributed over more people).

In aspects, the CFC 132 also determines a carbon footprint of the transportation needed or requested to arrive at the destination location of a traveler's itinerary.

In aspects, the CFC 132 asks travelers if they have already offset at least a portion of their carbon footprint and subtract that value from the total value of the carbon footprint of the travel itinerary.

In aspects, the CFC 132 is configured to determine the carbon footprint of each individual on the itinerary. Before or after the CFC 132 determines the carbon footprint of each room type, the CFC asks travelers how many people and who (e.g., children, groups, pets, etc.) are planning on traveling, and calculates the carbon footprint of each room type based on a predetermined factor related to the number or type of person(s) on the itinerary. For example, a 4 person family with two adults and two kids staying in a single room may use the same electricity as a 3 person family, but may require more laundry services, product services, water consumption, etc. Thus the 4 person family may have a larger carbon footprint collectively than a carbon footprint of three adults staying in the same room. The CFC 132 calculates the carbon footprint of each individual and displays the carbon footprint of each individual and the group as a whole. The travel planning system 100 enables each individual of an itinerary to determine their carbon footprint and offset the carbon footprint or predicted carbon footprint related to just the portion the individual is responsible for.

In aspects, the CFC 132 is configured to determine the carbon emissions of the products and other services used by the provider. The CFC 132 may determine the carbon emissions of carbon consuming and/or generating items such as the trash consumed, plastics used, shampoos, soaps, tissues, paper towels, bottles, cups, shower caps, and other similar in-room products, and/or other products used by the provider (e.g., chlorine used in a pool on site). Thus the CFC 132 may determine the carbon emissions of a life cycle (past and future) of an item. The CFC 132 collects carbon emissions data related to the manufacturing, transportation, use, and/or disposal of those products. For example, if a provider received a shipment of shampoo bottles monthly, the CFC 132 determines the carbon emissions used in creating the shampoo, the shampoo bottles, transporting the shampoos (refined by, for example, distance or mode). If carbon emissions data for a specific product or service is unavailable, the CFC 132 may calculate the carbon emissions based on pre-determined factors. The predetermined factors may change based on location of the provider or type of product for which the carbon emissions are being calculated.

The CFC 132 may also calculate the carbon footprint of each room based on amenities in the room that may have a carbon footprint, for example, due to electricity usage. Providers may include in their listing's kitchenettes, microwaves, dishwashers, irons, microwaves, hotplates, number of lamps and lights, type of lighting (e.g., LED bulbs or mercury containing CFL bulbs), type of ACs, etc., and the specific brands and model numbers. The CFC 132 is able to break down the carbon footprint of each room type based on the carbon emitting or carbon consuming items in each room type and illustrate to a traveler or provider how minimizing use of such items may reduce their carbon footprint. The CFC 132 may calculate the carbon footprint associated with the manufacturing and development of the furniture, bedding, or upholstery.

The CFC 132 may also determine the carbon footprint related to cleaning services and activities, such as that due to the chemicals used for mopping or cleaning surfaces or the use of an industrial vacuum.

The CFC 132 may determine the carbon footprint related to food services such as restaurants or continental breakfasts (e.g., the food carbon footprint). The CFC 132 determines the carbon emitted based on the number and types of ovens, and if available, best on data provided by the oven manufacturer. The CFC 132 determines the carbon emissions due to the refrigerators, freezers, coolers, food preparation, food delivery, food or kitchen waste, waste disposal and/or transportation, or dishwashers.

The CFC 132 may determine how much carbon is emitted by its employees, based on, for example, whether the employees drive a gas engine car or take public transportation, or simply walk. The CFC 132 may also determine the carbon emissions due to any business travel by an employee.

With reference to FIGS. 13-19, an exemplary system admin UI is illustrated. The system admin UI enables system administrators to create new listings for providers, may input answers to listing data and carbon emission data questionnaires (as discussed above), and may enable the CFC 132 to determine the carbon footprint due to required or requested transportation in a travel itinerary (e.g., a plane ticket or rental car) in addition to the carbon footprint of each listing.

With reference to FIG. 13, a system administrator may configure the CFC 132 for each provider by enabling or disabling various aspects of the CFC 132.

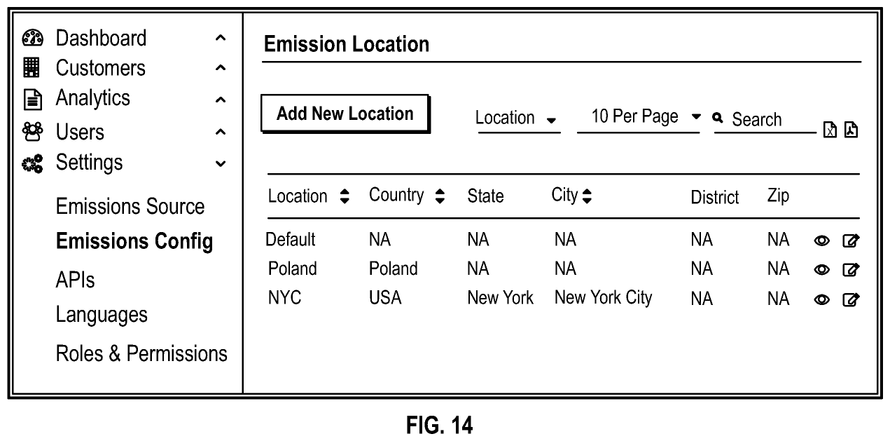

With reference to FIG. 14, the system administrator UI enables a system administrator to add to the listing data by creating new or updating current provider listings and locations (e.g., a hotel in New York, N.Y.).

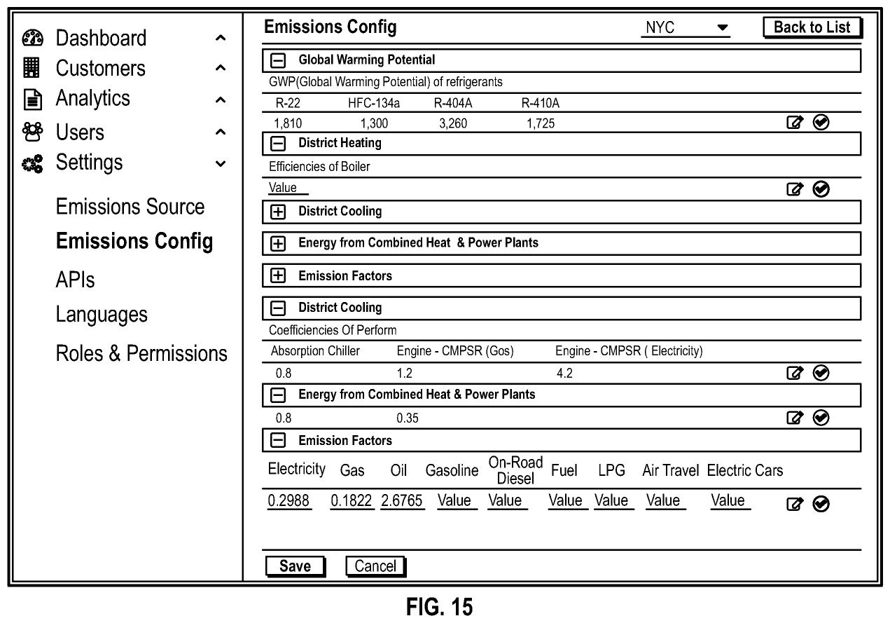

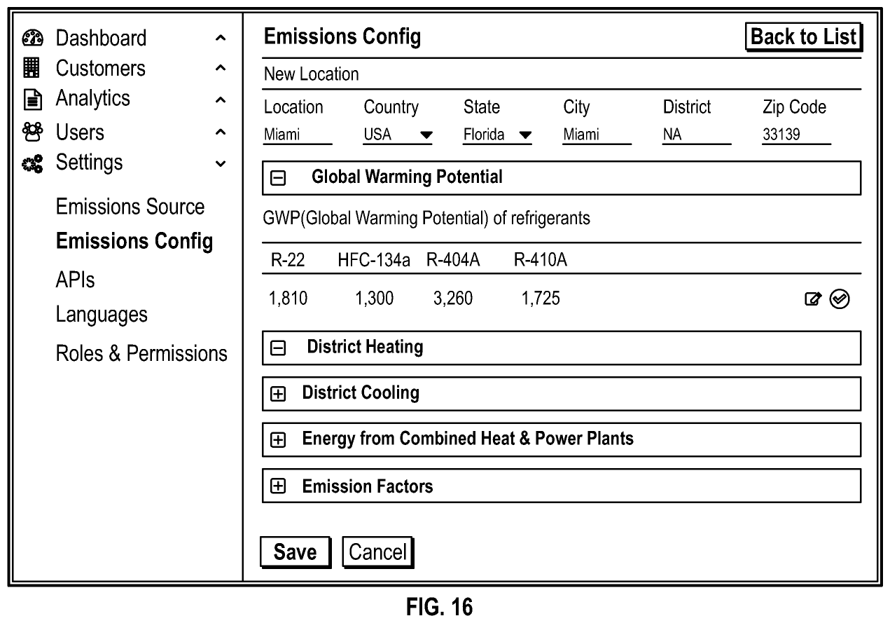

With reference to FIGS. 15 and 16, the system administrator UI enables a system administrator to input new and/or update listings data or emissions data, including, but not limited to, the Global Warming Potential of various refrigerants, efficiencies of a boiler for district heating, district cooling quantity purchased and related coefficient of performance, and the various emission factors.

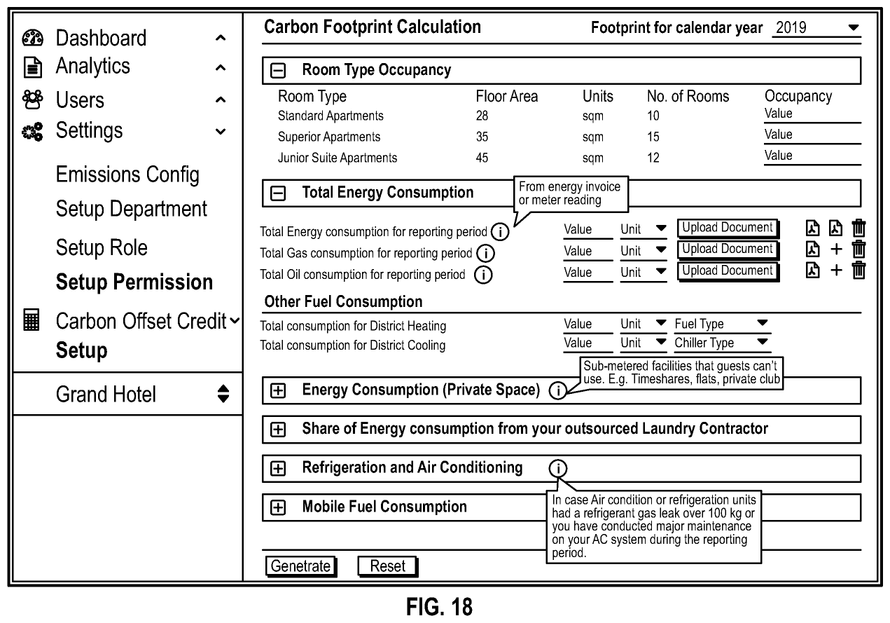

With reference to FIGS. 18-20D, an exemplary system administrator UI and exemplary provider UI are shown, and enable a system administrator or provider to input any of the listings data into the CFC 132.

With reference to FIGS. 21 and 22, the travel planning system 100 receives a traveler input for an itinerary and enables the traveler to select the number of rooms and room type. The CFC 132 determines the carbon footprint due to that itinerary and displays the carbon footprint to the traveler, for example, via a carbon footprint and COPs UI 2200. Display 2210 displays the carbon footprint to the traveler. Display 2220 offers COPs the user may contribute to, to reduce their net carbon footprint. The COPs displayed may be determined based on available COPs stored in the database. The travel planning system 100 enables travelers to choose one or more COPs to contribute to, to reduce the traveler's carbon footprint. The travel planning system 100 may provide various visualization charts to illustrate the effect or amount of carbon emissions that the traveler may more easily understand or relate to.

For example, a traveler may contribute $100.00 to building a solar panel energy “farm” that reduces the amount of carbon that might be emitted due to a carbon emitting power plant, such as a natural gas-steam power plant. The $100.00 corresponds to an amount of carbon emitted, (e.g., 4 tons of carbon); thus if a traveler was a passenger on a bus and stayed in a hotel that together had a carbon footprint of 3.5 tons of carbon, as determined by the CFC 132, the traveler would have a negative 0.5 ton carbon footprint.

The travel planning system 100 is configured to COPs listings data manually input or from other sources, such as governments or utilities, that manage and run COPs. A feed of COPs may be received by the travel planning system to establish a central COPs database instead of requiring travelers to seek out each COP individually, since there is no current centralized database of COPs. The travel planning system 100 is configured to enable other systems or services to access the COPs database so they may offer the COPs to others (e.g., travelers on another website or those wishing to reduce their net carbon footprint at home) so they may contribute to the COPs without searching, planning, or booking a travel itinerary through the travel planning system 100. The COPs stored in the central COPs database may be accessed and distributed by a distribution channel (e.g., airline services or local experience providers) globally or in local areas.

The travel planning system 100 is configured to determine an optimal COP to a provider, traveler, or other interested party seeking to contribute to or offer a COP. Travelers or providers may create profiles storing preferences such as locations, destination types, project types (e.g., ocean clean-up or solar energy farm), etc. The travel planning system 100 identifies COPs that match a profile. The travel planning system 100 may determine optimal COPs to display and offer a traveler or profile based on location of the provider or details (e.g., experiences) of an itinerary. For example, a traveler booking an itinerary to a location near a rain-forest may be matched to a COP that works to prevent deforestation and instead plants more trees to offset carbon released in the atmosphere. COPs may be displayed based on locality, provider owned COPs, global projects, and government or organizational managed COPs. The COPs may be displayed based on traveler behavior and history. Computer vision, artificial intelligence, or similar smart computer algorithms may be used to identify the COP that may be most appealing to a traveler, and may include an analysis of the travelers prior travel itineraries, a connected social media account, experiences on the travelers travel itinerary, and the like. Computer vision, artificial intelligence (AI), and similar smart computer algorithms may similarly determine the carbon footprint of the travel itinerary or experience and match the determined carbon footprint and/or itinerary with a COP. The travel planning system 100, via computer vision, AI, or the like, may be receive a travel itinerary inquiry, and carbon emission data from a database or from one or more sensors, to determine a carbon footprint based on real-time and predicted conditions (e.g., including based on weather, travel dates, number of other people traveling not related to the itinerary, etc.).

In aspects, providers may manage and fund their own COPs which may be displayed and offered to a traveler to contribute too. In other aspects, travelers may purchase COPs and receive provider credits or cash that may be spent at the provider's listings. For example, if a traveler contributes $150.00 to a COP to offset ten metric tons of carbon emissions, a provider may offer the traveler $50 towards a nights stay or use in a restaurant at the provider's facility.

The travel planning system 100 includes a traveler profile system configured to track travelers' itineraries and COPs contributions. The traveler profile system allows providers to participate or create loyalty and rewards incentives. Rewards and incentives may be based on the total carbon offset by the traveler or the number of stays the traveler has at the provider. The traveler profile system may include a digital wallet that converts a portion of the amount contributed to COPs by the traveler to credits and rewards. The traveler profile system stores COPs certificates issued to the traveler. The travel profile system may allow users to store COPs purchased elsewhere or manage travel itinerary reservations from other travel planning systems, thus enabling travelers to easily and simply determine their travel related carbon footprints and reduce their carbon footprints even while planning and reserving travel itineraries through other legacy travel planning systems. The travel planning system 100 improves the ability of a traveler to offset and/or reduce their carbon footprint by combining the ability to create a travel itinerary and to book, view, or see travel listings and the associated carbon footprint and to be able to then offset the carbon emissions that are attributable to the travel itinerary. The travel planning system 100 thus enhances efforts to reduce global carbon emissions.

The travel planning system 100 includes a COP on-boarding engine. The COP on-boarding engine is configured to enable others to submit COPs to be entered into and stored in the COPs listings database. The COP on-boarding engine is configured to verify or pre-qualify a COP.

The travel planning system 100 may include a carbon footprint reduction forum (CFRF) configured to help providers determine best practices for reducing their carbon footprint or for marketing their services. CFRF may be configured to determine which sources or vendors of energy or other carbon producing or reducing products or which practices of providers lead to the smallest carbon footprint of providers, so that other providers may implement those practices or use the same sources or vendors as those providers with smallest carbon footprint offering similar listings. For example, the CFRF may provide an analysis or recommendation to a small bed and breakfast ways they can minimize their carbon footprint based on other bed and breakfasts in a nearby location with a smaller carbon footprint. The CFRF is configured to allow providers or travelers to communicate with one another so each may learn better carbon reducing practices.

The travel planning system 100 may generate and display real time carbon footprint charts and other visual information by destination, locality, and provider. The travel planning system enables providers and/or travelers to view the carbon footprints of each room or whole facility or service in real time and may view past information. The travel planning system enables providers and consumers to see the progress of the sustainability efforts by the provider and if they are improving (smaller carbon footprint), stagnant (same carbon footprint), or deteriorating (larger carbon footprint). The travel planning system 100 may display relatable graphics that compare the carbon footprint of the travel itinerary to an understandable equivalent thereof. For example, the travel planning systems may compare a number of straws produced or a number of towels washed that may be more easily understood by a traveler or user to the carbon footprint of the travel itinerary (see FIG. 22).

The travel planning system 100 enables travelers to reserve and book experiences or activities. The CFC 132 is configured to determine or quantify the carbon emissions or pollution due to the experiences. For example, the travel planning system may display to a traveler a listing of boat rental companies and the carbon emissions related to reserving use of the boat. The experiences may include anything from museums to nature excursions, to local volunteering opportunities, and other activities. The travel planning system may display sustainable experiences that have little carbon emissions, neutral carbon emissions, or help reduce carbon emissions. For example, the travel planning system 100 may recommend a ‘hiking and forestation experience’ where travelers are taken on a guided tour of a mountain and plant new trees or shrubs on the hike. Thus the travel planning system 100 is configured to enable travelers to determine the representative carbon emissions of their travel plans, without which travelers would be unable to accurately and without hassle determine.

The travel planning system 100 is further configured to determine the carbon footprint related to transportation. Prior carbon footprint calculators restricted their calculations to that due to the fuel used in the mode of transportation between destinations (e.g., number of miles of a flight). In contrast, the CFC 132 of the travel planning system 100 determines the carbon emissions related to transportation based additionally on the total number of passengers of a flight (e.g., if a flight is only half full, then more carbon may be emitted per person), meals (e.g., plastic packaging, single-use utensils), drinks (e.g., non-recyclable plastic cups), entertainment, fuel source, weather, and flight paths. The CFC 132 is configured to also determine the carbon emissions due to the energy used at the transportation hub (e.g., the airport, luggage services, or waste removal from the airport). The CFC 132 distinguishes between types of aircraft, trains (rail types), boats, cars, marinas, scooters, motorcycles, RVs, etc. that may be involved in the travel plans, and determines the carbon emissions related to the specific travel modes (large cruise ship or small ferry). The CFC 132 may include a path tracker for tracking travel by car or bus.

The phrases “in an embodiment,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A), (B), (C), (A and B), (A and C), (B and C), or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached figures are presented only to demonstrate certain examples of the disclosure. Other elements, steps, methods, and techniques that are insubstantially different from those described above and/or in the appended claims are also intended to be within the scope of the disclosure.

What is claimed is:

1. A travel planning system for determining a carbon footprint of a travel itinerary, comprising:
a graphical user interface (GUI) including a display;
a processor; and
a memory, including instructions stored thereon, which, when executed by the processor, cause the system to:
receive input from the GUI, the input including a travel itinerary inquiry;
determine at least one provider listing to be displayed based on the received travel itinerary inquiry;
display the determined provider listing on the GUI;
receive a second input from the GUI, the second input including a listing selection from the at least one provider listing displayed;
determine a carbon footprint value based on the listing selection; and
display the carbon footprint value and the listing selection on the GUI;
wherein the travel itinerary inquiry is at least one of an accommodations inquiry, transportation inquiry, or experiences inquiry.

2. The system of claim 1, wherein the carbon footprint value is further based on at least one of: the travel itinerary inquiry, carbon emissions data, or listings data.

3. The system of claim 1, wherein determining the carbon footprint value includes determining at least one of a stationary emissions total, mobile fuel emissions total, a fugitive emissions fuel total, electricity emissions total, district heating emissions total, district cooling emissions total, or emissions due to laundry total.

4. The system of claim 1, wherein the carbon footprint value is determined by determining the carbon emissions value of the in-room products, fuels, water, cleaning services, food, waste, furniture, and objects consumed or used by the provider's service or facility.

5. The system of claim 1, wherein the carbon footprint value is further determined based on travel dates of the travel itinerary inquiry and an amount of travelers of the travel itinerary inquiry.

6. The system of claim 5, wherein the instructions, when executed by the processor, further cause the system to determine the carbon footprint value of each traveler of the amount of travelers and display the carbon footprint value of each traveler based on the listing selection on the GUI.

7. The system of claim 1, wherein the instructions when executed by the processor, further cause the system to:
determine at least one carbon offset project to be displayed based on the travel inquiry; and
display the carbon offset project on the display.

8. The system of claim 3, wherein the instructions when executed by the processor, further cause the system to:
receive a third input from the GUI including a selection of the at least one carbon offset project.

9. The system of claim 8, wherein the instructions when executed by the processor, further cause the system to:
process a carbon offset project payment based on the carbon offset project selection; and
book a reservation based on the listing selection with a provider.

10. A computer-implemented method for determining a carbon footprint, comprising:
receiving input from a graphical user interface (GUI) of a display, the input including a travel itinerary inquiry;
determining a provider listing based on the received travel itinerary inquiry;
displaying the determined provider listing on the GUI;
receiving a second input from the GUI, the second input including a selection of the provider listing;
determining a carbon footprint value based on the selection of the provider listing; and
displaying the carbon footprint value and the provider listing selection on the GUI.

11. The computer-implemented method of claim 10, wherein the carbon footprint value is further based on at least one of: the travel itinerary inquiry, carbon emissions data, or listings data.

12. The computer-implemented method of claim 10, wherein determining the carbon footprint value includes determining at least one of a stationary emissions total, mobile fuel emissions total, a fugitive emissions fuel total, electricity emissions total, district heating emissions total, district cooling emissions total, or emissions due to laundry total.

13. The computer-implemented method of claim 12, wherein determining the carbon footprint value includes determining the carbon emissions value of the in-room products, fuels, water, cleaning services, food, waste, furniture, and objects consumed or used by the provider's service or facility.

14. The computer-implemented method of claim 13, wherein the carbon footprint value is further determined based on travel dates of the travel itinerary inquiry and an amount of travelers of the travel itinerary inquiry.

15. The computer-implemented method of claim 14, further including determining the carbon footprint value of each traveler of the amount of travelers and displaying the carbon footprint value of each traveler based on the listing selection on the GUI.

16. The computer-implemented method of claim 14, further including:
determining a consumer carbon offset project to be displayed; and
displaying, on the display, the consumer carbon offset project.

17. The computer-implemented method of claim 16, further comprising:
receiving a third input from the GUI indicating a consumer carbon offset project selection;
processing a carbon offset project payment based on the consumer carbon offset project selection; and
booking the provider listing selection.

18. A computer implemented method for reserving a travel itinerary, the method comprising:
receiving, via a graphical user interface (GUI) of a display, a listings selection from a list of provider listings displayed on the display;
determining a carbon footprint associated with the listings selection;
displaying the determined carbon footprint;
determining at least one consumer carbon offset project to be displayed;
receiving, via the GUI, at least one selection from the carbon offset projects displayed on the display; and
receiving a payment based on the at least one selection from the carbon offset projects displayed on the display.

19. The method of claim 18, further comprising: reserving the listings selection from the list of provider listings with a provider.

20. The method of claim 18, wherein the list of provider listings includes at least one of an accommodation listings, a transportation listing, or an experience listing.
